(19) United States
(12) Patent Application Publication
(10) Pub. No.: US 2025/0062612 A1
(43) Pub. Date: Feb. 20, 2025

(54) DISTRIBUTED LEDGER TECHNOLOGY FRAMEWORK FOR POWER GRID INFRASTRUCTURE

(71) Applicant: UT-Battelle, LLC, Oak Ridge, TN (US)

(72) Inventors: Raymond C. Borges Hink, Knoxville, TN (US); Gary Hahn, Loudon, TN (US); Aaron W. Werth, Knoxville, TN (US); Emilio C. Piesciorovsky, Oak Ridge, TN (US)

(21) Appl. No.: 18/806,951

(22) Filed: Aug. 16, 2024

Related U.S. Application Data
(60) Provisional application No. 63/533,144, filed on Aug. 17, 2023.

(51) Int. Cl. H02J 3/00; H04L 43/0829; H04L 43/087

(52) U.S. Cl. CPC H02J 3/001; H04L 43/0829; H04L 43/087; H02J 2203/10

(57) ABSTRACT

An attestation framework to support attestation and anomaly detection in an electric grid. The attestation framework provides systems and methods that use distributed ledger technology (DLT) and implement DLT-based methods for verifying device and data trustworthiness on the electric grid. The framework attests to system changes and anomaly detection to flag specific events such as natural and cyber-induced grid events categorization, electrical faults in meters and relays and cyber events, e.g., based on statistical and baseline threshold values. The attestation framework can support the detection of system changes by itself, and in combination with an anomaly detection framework, has a lower system resource requirement and is more likely to catch system changes. An anomaly detection module can trigger attestation checks and uses the DLT for device and configuration verification purposes. The attestation framework can be deployed at substations or other environments, such as DERs or a microgrid.

### CROSS REFERENCE TO RELATED APPLICATION

The present application claims benefit of U.S. Provisional Application No. 63/533,144 filed on Aug. 17, 2023, all of the contents of which are incorporated herein by reference.

### STATEMENT REGARDING FEDERALLY SPONSORED RESEARCH OR DEVELOPMENT

This invention was made with government support under project DE-AC05-00OR22725 awarded by the U.S. Department of Energy. The government has certain rights to this invention.

### BACKGROUND

Adverse events in recent decades have impacted electric grids. For example, malware that sent commands from a control center after an attacker had compromised computers, such as the human-machine interface (HMI) in the control center, led to a power grid shutdown of a large power system. Faults, such as the one leading to a blackout, have also been harmful. These events are a major cause of concern given the complexities in the national grid. One cyber event or equipment failure can lead to cascading outages or even further damage to the critical infrastructure needed for society to function.

Trustworthiness of devices and data within the electric grid is under intense scrutiny as the attack surface of these networks has substantially increased. Varying degrees of system and network sophistication exist among the layers and levels of the electric grid. In many cases, different entities, e.g., utilities, own and operate different parts of the grid, from generation to distribution. These factors make the nation's smart grid a heterogeneous and complex infrastructure. Furthermore, vast amounts of distributed energy resources (DERs) in future applications could be integrated, which are “small, modular electricity-generating or storage technologies that are located close to the load they serve”. These DERs and utilities are owned and operated by different entities, and these entities rely on each other and external regulatory organizations to optimize energy delivery. A framework of trust is needed across utilities and DER organizations to operate safely and securely in the face of potential electrical faults/failures and cyber events.

With the increased vulnerability and risk that exists for adversarial manipulation of information, data, control signals, and so on transported over various communications topologies, e.g., Wi-Fi, wireless networks, the Internet, long-distance fiber networks, data and device trustworthiness are critical. There is ample opportunity for data modification and remote cyber events on grid devices. The two-way exchanges of data/information that need to routinely occur among the advanced/automated metering infrastructure, control centers, energy aggregators, end-user energy management system, and grid monitoring/control devices/systems to help optimize grid control also present a potential increased security risk, e.g., by allowing more communication than previous one-way paths. Electric grid systems are therefore in need of remote attestation methods that can support data and device integrity using robust methods that can accommodate the various generations of existing software and middleware technologies, hardware/devices, and network configurations on the smart grid.

### SUMMARY

A framework including systems and methods to facilitate the correct functioning of the components in an electric grid to verify that the data and devices can be trusted, and to support attestation and anomaly detection in the electric grid.

An approach using distributed ledger technology for verifying that the configuration of devices has not been illegitimately modified from the last known correct settings and for detecting anomalies and discrepancies in the data being shared between devices when compared with last known correct baselines so that the overall system can be protected.

A distributed ledger technology (DLT) framework that relies on a Hyperledger Fabric implementation of a blockchain and uses blockchain-based methods for verifying device and data trustworthiness on the electric grid. The framework may also rely on another consensus algorithm and implementation of blockchain or DLT.

In an aspect, the employed framework is agnostic to the environment where it is deployed. Such environments can include electric-grid substations or other environments, such as future applications with DERs or a microgrid, and can ingest data from the network and secure the data with the blockchain.

In one aspect, there is provided a system for electrical energy delivery. The system comprises: multiple electrical grid devices each configured to transmit associated electrical grid data signal values and associated device-configuration data over a communications network; one or more hardware processor devices communicatively coupled with the electrical grid devices through the communications network, the one or more hardware processor devices configured to receive electrical grid data signal values from an electrical grid device and the associated device-configuration from the electrical grid device and apply a hash function to the associated device-configuration data received from the electrical grid device; at least one distributed ledger technology (DLT) data storage device communicatively coupled with the one or more hardware processor devices through the communications network, each of the at least one DLT data storage device storing an instance of a ledger, the DLT data storage device configured to store in the ledger the hashed device-configuration data; the one or more hardware processor devices further configured to extract features of the electrical grid data signal values received from the electrical grid device during real-time operation; the one or more hardware processor devices further configured to detect an anomalous event based on the extracted features; and responsive to detection of an anomalous event, the one or more hardware processors verifying an integrity of the corresponding electrical grid device using the hashed device-configuration data for that corresponding electrical grid device stored in the at least one DLT data storage device.

In a further aspect, there is provided a method for managing information associated with an electrical utility grid. The method comprises: receiving, at one or more hardware processors of a computing node, electrical grid data signal values and associated device-configuration data transmitted from multiple electrical grid devices over a communications network; storing, by the one or more hardware processors of a computing node, electrical grid data signal values and associated device-configuration data at an off-chain data storage device communicatively coupled with the one or more hardware processors through the communications network; applying a hash function to the associated device-configuration data received from the electrical grid device to obtain a hashed associated device-configuration data value; storing the hashed device-configuration data at a ledger instance associated with at least one distributed ledger technology (DLT) data storage device communicatively coupled with the one or more hardware processor devices through the communications network; extracting, by the one or more hardware processors, features of the electrical grid data signal values received during real-time operation from the corresponding electrical grid device and storing extracted features in the off-chain database; detecting, by the one or more hardware processors, an anomalous event based on the extracted features of the electrical grid data signal values; and verifying, by the one or more hardware processors, responsive to detection of an anomalous event, an integrity of the corresponding electrical grid device using the hashed device-configuration data for that corresponding electrical grid device stored in the at least one DLT data storage device.

A computer-readable storage medium storing a program of instructions executable by a machine to perform one or more methods described herein also may be provided.

### BRIEF DESCRIPTION OF THE DRAWINGS

Further features as well as the structure and operation of various embodiments are described in detail below with reference to the accompanying drawings. In the drawings, like reference numbers indicate identical or functionally similar elements.

FIG. 1 depicts a system and method referred to as “Cyber Grid Guard” which is a Distributed Ledger Technology (DLT)-based remote attestation framework that uses blockchain-based methods for verifying device and data trustworthiness on the electric grid according to embodiments herein;

FIG. 2 illustrates a logic architecture implemented in the Cyber Grid Guard attestation framework of FIG. 1 including the architecture of the communication network and devices used therein;

FIG. 3 shows the overall data flow 300 of the Cyber Grid Guard attestation framework 10 of FIG. 1;

FIGS. 4A-4C depict alternative high-level overviews of the methods employed by Cyber Grid Guard attestation and anomaly detection framework of FIG. 1;

FIG. 5 shows a more detailed implementation of the data storage and DLT processing system and data storage capability of the Cyber Grid Guard attestation framework of FIG. 1

FIG. 6 illustrates the anomaly detection framework implemented by anomaly detection module of FIG. 1;

FIG. 7A shows an embodiment of an HLF DLT network configuration of the attestation framework;

FIG. 7B shows the HLF network of FIG. 7A using “Docker” to execute HLF components on each node DLT node according to an embodiment;

FIG. 8 shows an example corresponding DLT ledger data object including the key:value entry pairs;

FIG. 9 depicts a one-line diagram of an example electrical substation-grid configuration monitored by the Cyber Grid Guard attestation framework of FIG. 1;

FIG. 10 depicts an electrical substation-grid “testbed” interconnection of components that simulate operations of a control center of FIG. 2 for the Cyber Grid Guard attestation framework;

FIG. 11 depicts a configuration of a simulation master (SM_Master) block and simulation console (SC_Console) subsystems in an embodiment;

FIGS. 12A-12B depict a three-line diagram in MATLAB/Simulink® model corresponding to the single-line diagram of the electrical substation-grid circuit of FIG. 9 in an embodiment;

FIG. 12C shows a fault block circuit used for the simulating of grid test events that include the effect of the electrical fault in an embodiment of a test simulation in the MATLAB/Simulink® model depicted in FIGS. 12A-12B;

FIG. 13 shows an exemplary data acquisition circuit to collect signals from the protective relays and collect signals from the power meters with the OpWrite File block according to an embodiment;

FIG. 14 depicts an example OpComm block connecting scopes for visualizing the protective relays-in-the-loop and scopes for visualizing the power meters-in-the-loop according to an embodiment;

FIG. 15A depicts an example scope display for the protective relay and FIG. 15B shows an example scope display for the power meters;

FIG. 16 depicts a flowchart of a method for anomaly detection, in particular, to calculate the RMS current magnitude threshold to set the DLT algorithm for detecting the electrical fault events at the substation feeder relays in an embodiment;

FIG. 17A shows a DLT screen to detect power system fault events and artifact changes at the electrical substation-grid testbed;

FIG. 17B shows hashes for configuration files on the devices at the electrical substation-grid testbed with DLT;

FIG. 18A shows a single-line diagram of the power utility electrical substation-grid diagram of the testbed corresponding to the one-line diagram of an electrical substation-grid testbed power system shown in FIG. 9.

FIG. 18B shows event descriptions of example use-case scenarios for detecting cyber events and electrical line fault and ground fault state events according to the methods herein;

FIG. 19A shows DLT current data from the protective relays and the power meters and FIG. 19B show DLT voltage data from the protective relays and the power meters for Experiment 1.a of FIGS. 18A-18B;

FIG. 20A shows DLT current data from the protective relays and the power meters and FIG. 20B show DLT voltage data from the protective relays and the power meters for Experiment 1.b of FIGS. 18A-18B;

FIG. 21A shows DLT current data from the protective relays and the power meters and FIG. 21B show DLT voltage data from the protective relays and the power meters for Experiment 2.a of FIGS. 18A-18B;

FIG. 22A shows DLT current data from the protective relays and the power meters and FIG. 22B show DLT voltage data from the protective relays and the power meters for Experiment 2.b of FIGS. 18A-18B;

FIG. 23A shows DLT current data from the protective relays and the power meters and FIG. 23B show DLT voltage data from the protective relays and the power meters for Experiment 3.a of FIGS. 18A-18B;

FIG. 24A shows DLT current data from the protective relays and the power meters and FIG. 24B show DLT voltage data from the protective relays and the power meters for Experiment 3.b of FIGS. 18A-18B;

FIG. 25A shows DLT current data from the protective relays and the power meters and FIG. 25B show DLT voltage data from the protective relays and the power meters for Experiment 3.c of FIGS. 18A-18B;

FIG. 26A shows DLT current data from the protective relays and the power meters and FIG. 26B show DLT voltage data from the protective relays and the power meters for Experiment 3.d of FIGS. 18A-18B;

FIG. 27A shows DLT current data from the protective relays and the power meters and FIG. 27B show DLT voltage data from the protective relays and the power meters for Experiment 4.a of FIGS. 18A-18B;

FIG. 28 depicts an overview of the software methods invoked at the anomaly detection module according to an embodiment;

FIG. 29 depicts an overview of the attestation methods invoked at the verifier module according to an embodiment;

FIGS. 30A-30C shows methods and constraints for the MeasurementHashAudit smart contract according to an embodiment;

FIGS. 31A-31C shows methods and constraints for the ArtifactHashAudit smart contract according to an embodiment; and

FIG. 32 depicts an example use case scenario depicting a substation that provides the framework to support attestation and anomaly detection and implemented to provide attestation services for other independently owned microgrids.

### DETAILED DESCRIPTION

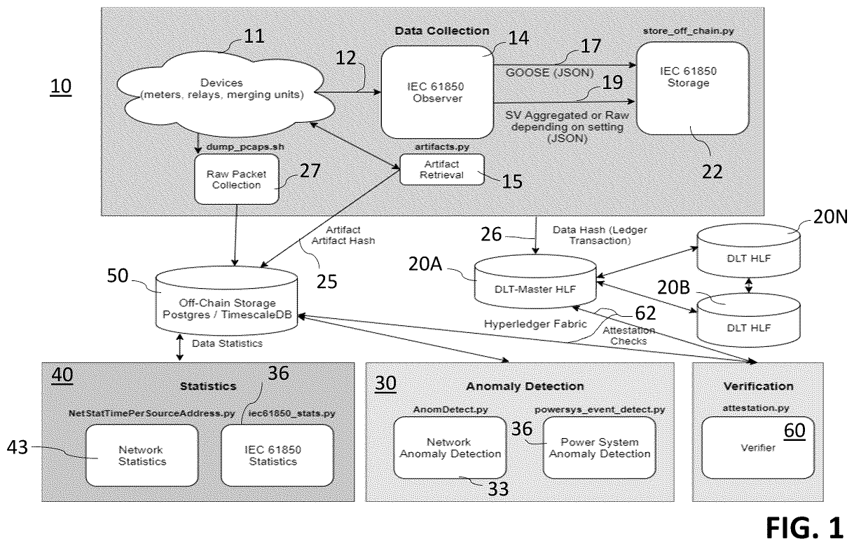

FIG. 1 depicts a system and method referred to as “Cyber Grid Guard” which is a Distributed Ledger Technology (DLT)-based remote attestation framework 10 that uses blockchain-based methods for verifying device and data trustworthiness on the electric grid. In an embodiment, a DLT, implemented using Hyperledger Fabric or another consensus algorithm and approach, is used for achieving device attestation and data integrity within and between grid systems, subsystems, and apparatus including electrical grid devices 11, such as relays and meters on the power grid.

In one approach, attestation framework 10 runs systems and methods employing an observer 14 that captures power grid data 12 and device configuration settings (artifacts) data 15 to better diagnose and respond to cyber events and/or electrical faults, either malicious or not malicious. The data 12 includes sensor commands and values sent over International Electrotechnical Commission (IEC) 61850 standard protocols, including GOOSE (Generic Object-Oriented Substation Events) data 17 according to GOOSE protocol and aggregated or raw SV (Sampled Values) data 19 according to SV protocol. All IEC 61850 data 17 on the network and SV data 19 is captured by using function 22 configured to store IEC 61850 data in an off-chain storage device. In an embodiment, a raw packet collection function 27 collects raw packets for storage in an off-chain data storage device 50.

The attestation framework 10 includes a distributed ledger technology (DLT) developed to enable the performance of these functions. The framework includes a set of blockchain computers, referred to as DLT nodes 20A, 20B, . . . , 20N on a network, each node comprising ingesting data for a blockchain, with one DLT node 20A designated as a master node. In addition, each DLT node can be set at a specific geographical location inside or outside of an electrical substation.

In an embodiment, the DLT nodes 20A, 20B, . . . , 20N store the data from the network and preserve the data immutably and redundantly across the nodes. The data captured include voltage and current as time series data in a raw form as time-sampled alternating current (AC) signals and root mean square (RMS) values. Other data captured include the configuration data of relay and meter devices 11 on the power grid. The nodes communicate with one another to establish a consensus of the data. The DLT nodes 20A, 20B, . . . , 20N can also manage the situation when some of the nodes are compromised by cyber events or malfunction, perhaps owing to equipment failure.

As referred to herein, DLT encompasses various technologies that implement data storage in the form of a shared ledger. Ledgers are append-only data structures, where data can be added but not removed. The contents of the ledger are distributed among designated nodes within a DLT network. Consensus mechanisms enable the shared ledger to remain consistent across the network in the face of threats such as malicious actors or system faults. Peer-to-peer communication protocols enable network nodes and participants to update and share ledger data.

To provide the necessary functionality to implement a DLT, these components are typically grouped and made available as DLT platforms.

### Permissionless And Permissioned DLTs

There are two general categories of DLTs—permissionless and permissioned. In a permissionless/public DLT, the network is open and available to anyone to participate in the consensus process that blockchains use to validate transactions and data. There are no administrators to control the DLT or define access requirements. In the research for the electric sector, DLT is mostly used for energy transactions—the buying and selling of energy. The DLTs used for this application are sometimes permissionless/public for the increased decentralization and transparency.

The alternative is a permissioned/private DLT that is not publicly accessible. The DLT can only be accessed by users with permissions, and the users may perform only specific actions assigned by an administrator. User identification and authorization is required before accessing the DLT.

### Consensus Algorithms

As referred to herein, consensus is the process by which a network of nodes provides a guaranteed ordering of transactions and validates the content of the block of transactions. Once consensus is reached, the decision is final and cannot be modified or reversed, without detection.

There are two classes of consensus: lottery-based and voting-based. Lottery-based algorithms include several of the “proof” algorithms, such as proof-of-work and proof-of-stake. Voting-based algorithms include practical byzantine fault tolerance (PBFT) and crash fault tolerance.

### Smart Contracts

As referred to herein, a smart contract creates digital assets; reads or writes transactions; and queries transactions in the ledger. Smart contracts do not operate on data external to the ledger. They operate on the data received as arguments to their functions and the data in the ledger. Any data required by a smart contract must be included in the ledger. In the context of a blockchain ledger for a power grid infrastructure, smart contracts implement transaction logic to send or query the measurements and artifact hashes data 25 stored at the DLT ledger.

### Transactions

As referred to herein, a transaction is how a user (sender) interacts with the ledger. As shown in FIG. 1, transactions 26 use smart contract functions to create, update, or query assets in the ledger. The first step involves the sender constructing a transaction proposal, which is signed using a private key and sent to a peer. One or more peers with the endorser role will then inspect the proposal and, if valid, allow the transaction process to continue. If the transaction involves a query, then the peer will simply retrieve the data from the ledger and return it. Otherwise, if the transaction invokes a function that updates the ledger, the transaction will then be executed and returned. For the ledger to be updated, it must be prepared for ordering in a block. The ordered transaction is then subject to final validation by the peers and added to the ledger.

### Cryptography

Cryptography plays an important role in a DLT, including the functionality of the core data structure and the authentication of users and transactions. The main cryptographic primitives that enable these features include cryptographic hashes for data integrity and public key cryptography for authentication.

Cryptographic hash functions map input data of an arbitrary size to a fixed-size output. The output of these functions cannot be used to obtain the original input data. SHA256 (secure hash algorithm) is a commonly used standard cryptographic hash algorithm that outputs a 32-byte (256 bits) value.

Blockchains are a common data structure used in distributed ledgers. A blockchain includes blocks of data that are linked together (i.e., the chain) using cryptographic hashes. These hashes provide immutability for the blockchain in the sense that any modifications of the data within any linked block will result in the calculation of an invalid hash when verifying the blockchain. This will indicate some type of data alteration that may be malicious or result from a failure.

Public key cryptography involves the use of public-private key pairs. The private key must be kept secure and possessed only by its owner, whereas the public key can be shared with and used by anyone. In a DLT, each transaction 26 is signed with a private key. The transaction is verified with the associated public key and the transaction is authenticated. Also included is data integrity. Any alteration of the transaction will result in an invalid signature verification.

### Cyber Grid Guard

The attestation framework 10 of FIG. 1 is designed to strengthen the resilience/security of an electric grid by increasing trustworthiness of devices and data. The ever-evolving smart grid topology, particularly with the deployment of DERs, and communication methods demand a sophisticated mixture of technologies to ensure security and data integrity. Cyber Grid Guard helps to ensure the trustworthiness of the data, systems, and devices that keep the nation's grid operating safely, reliably, resiliently, and securely. Cyber Grid Guard provides attestation using HLF for data measurements and device artifacts and portrays a more comprehensive grid/device health monitoring alternative to existing SCADA (Supervisory Control and Data Acquisition) implementations.

As mentioned, Cyber Grid Guard attestation framework 10 focuses on two major areas: DLT and data/device attestation. Devices 11 include relays and meters in power systems, specifically at substations, and potentially in future applications with microgrids and DER devices. Cyber Grid Guard uses a permissioned DLT that is deployed in a utility substation and at a utility control center. Sensor data are received from meters at the substation. Cyber Grid Guard also implements a data/device attestation methodology using DLT. The DLT remote attestation framework includes anomaly detection of device data and device configuration.

Cyber Grid Guard attestation framework 10 is intended to be deployed in an Operational Technology (OT) environment and address data and device integrity for substations and linked DER devices. DLT applies to environments with distributed processing and limited central management. The objective is to ensure the integrity of the data and devices.

DLT Cyber Grid Guard facilitates data and device attestation by storing hashes of the data in the ledger and storing the data outside of the ledger in off-chain storage database 50. The hashes are used to validate the integrity of the data. Because the DLT Cyber Grid Guard system is intended to be implemented in a distributed environment, remote attestation is necessary. Remote attestation includes a verifier module 60 that validates data from a prover. There are three types of attestation: hardware-based, software-based, and hybrid. Hardware-based remote attestation leverages physical devices/chips and modules to achieve remote attestation. Software-based remote attestation does not rely on any hardware to perform remote attestation. Hybrid remote attestation includes both hardware and software components. Because many of the devices in the electric grid have limited processing and storage capacity, Cyber Grid Guard implements software-based remote attestation.

To this end, in view of FIG. 1, the Cyber Grid Guard attestation framework 10 further includes an anomaly detection module 30 that includes two software modules: a Network Anomaly Detection Module 33 for detecting anomalous network traffic events and a Power System Anomalies Detection Module 36 that uses the IEC 61850 data for detecting anomalous electrical fault and device configuration events. Each anomalous detection module 33, 36 triggers further actions by a verifier module 60 responsive to detected anomalous events. The framework employs the verifier 60 and a prover, e.g., aka a device attempting to prove its trustworthiness 11. In an embodiment, the verifier 60 provides attestation checks 62 performed using a challenge-response mechanism upon the verifier's requests.

Referring to FIG. 1, the nodes 20A, 20B, . . . , 20N in the Cyber Grid Guard attestation framework 10 are considered crash-fault tolerant, meaning that if most of the nodes remain uncompromised, the DLT nodes can establish the true state of the data to compare the current system and network data to validate trustworthiness. To compare baselines, various methods were used. For device configuration artifacts, hash values were compared with predetermined baselines from power meters and protective relays.

In an embodiment, Cyber Grid Guard leverages a power grid timing and synchronization system, such as Oak Ridge National Laboratory's Center for Alternative Synchronization and Timing, to provide robust nanosecond-precision timing, and software-based processes to create baselines for remote attestation of devices within and between grid systems such as substations, control centers, and the advanced/automated metering infrastructure. The Cyber Grid Guard attestation framework 10 is useful for providing data integrity as well as attestation of device configurations.

When applied to larger data sets, e.g., waveforms or data from high-fidelity sensors, Cyber Grid Guard attestation framework 10 produces hashes 26 that are stored in the blockchain ledgers at the DLT nodes 20A, 20B, . . . , 20N. Therefore, it is scalable and less computationally intensive than storing records, and it consumes less energy to function. Cyber Grid Guard uses open-source Hyperledger Fabric (HLF) software to operate a blockchain-based distributed ledger that can provide data integrity and attestation of device configurations such as protection schemes and network and device communication settings.

Because the Cyber Grid Guard framework 10 includes devices that are distributed across various locations, remote attestation is required. By monitoring electrical device network traffic sent via IEC 61850 standard protocols such as GOOSE and SV, remote attestation verification is triggered when potentially malicious events/attacks are detected. To provide data integrity, Cyber Grid Guard employs sliding time windows to compare statistical grid and network data measurements with previously established baselines that are stored using cryptographic hash functions in the distributed ledger.

In an embodiment, a statistics module 40 is provided that is configured to interface with off-chain database storage 50 to process/store network traffic statistics 43 in addition to IEC 61850 protocol measurement statistics 36. Network anomaly detection model 33 continuously queries network statistics 43 captured using network statistics module 40 that collects data statistics pertaining to network traffic from the sub-stations. The statistics module 40 handles collecting network traffic via packet captures, calculating network statistics 43, and then inserting them into the off-chain network statistics database table in the off-chain storage device 50. When network anomaly detection module 33 detects one of the statistics has exceeded a threshold, a network anomaly event is inserted into the database and a device artifact attestation check is initiated.

The statistics module 40 uses various statistical methods to collect and analyze network traffic statistics 43. These methods include basic threshold calculations following IEEE standards and other common utility standards. Specifically, the module calculates interarrival packet time, packet loss rate, throughput, and jitter. These metrics are compared against predefined baseline values to detect anomalies. When an anomaly is detected, such as a significant deviation in packet interarrival times or an unexpected increase in packet loss rate, the anomaly detection module is triggered. The module then flags these events for further investigation, ensuring that any potential network issues or security threats are promptly addressed.

Similarly, the Power System Anomalies Module 36 leverages a vendor-specific API (e.g., BlueFrame) and additional control system software used to retrieve and store the artifacts 15 from the protective relays, power meters, network devices, and IEDs. The anomaly detection software only stores a hash of the statistical baseline patterns in the ledger for comparisons used to detect anomalous events. These statistics are useful to establish a measurement data profile of behavior for the sensor data and network. When the Cyber Grid Guard framework 10 has collected new data into the database, these new data may be compared with the statistics 36 to determine if the profile of the new data is like or significantly different from the established profile. This statistics module 40 further collects and stores a window of data of a configurable duration, e.g., a predetermined duration of 1 minute of data, including multiple data streams to establish a statistical baseline for network communication and sensor patterns.

The BlueFrame API facilitates real-time data retrieval from various devices such as protective relays and meters. The API collects configuration data, status information, and sensor readings, which are then analyzed for anomalies. The types of anomalies detected include deviations from normal operational parameters, such as abnormal voltage and current levels, unexpected changes in breaker status, and unusual patterns in power factor or frequency. By continuously monitoring these parameters, the module can detect and respond to potential cyber threats or equipment malfunctions, ensuring the integrity and reliability of the power grid.

In view of FIG. 1, in an embodiment, the Verifier Module 60 implements a mechanism to monitor the generated blocks of data for attestation, including measurement data profiles used to make an initial determination of potential device compromise. This attestation process uses the hashed data from a ledger node 20A, 20B, . . . , 20N to provide remote attestation. Data are to be stored off-chain in the off-chain database 50 include the processed data that does not need to be stored on the blockchain but is essential for performing attestation checks using the hashes in the ledger. The stored data in the off-chain database 50 include baselines, system settings, analytics results, and other non-critical data that supports the anomaly detection system but may not require immutability. The stored on-chain data at a blockchain DLT node 20 includes critical information such as verified baselines, key anomaly detection results, and other essential data that benefit from the tamper-proof nature of blockchain.

The Cyber Grid Guard system 10 provides a remote attestation and anomaly detection approach and methodology, particularly for implementing the DLT platform to provide attestation and anomaly detection capabilities for electric grid data and electric grid devices. For grid data, the objective is to ensure that the data are within certain bounds and/or are sent at a standard frequency. If the data fall outside these standard bounds, e.g., data are anomalous, this may trigger an attestation check for the device. The list of devices includes protective relays, meters, Remote Terminal Units (RTUs) or real-time automation controllers (RTACs), and HMIs. Network devices include switches, routers, and firewalls. For devices, the focus is on ensuring the integrity of the configuration data (i.e., artifacts) such as protection scheme settings, network settings, and firmware configuration. For example, if an IP address setting of a device is changed, the device would not be able to communicate, and this could trigger an anomalous event.

### Attestation

Two mutually exclusive parties are involved in an attestation scheme: (i) the verifier via Verifier Module 60 in the Cyber Grid Guard framework 10, and the prover, e.g., aka a device attempting to prove its trustworthiness. Attestation is performed using a challenge-response mechanism upon the verifier's requests. During the execution of an attestation request, the prover does a measurement of a device, e.g., through a middleware application (e.g., BlueFrame API). The verifier receives the measurement and then determines whether the measurement represents a valid device state, i.e., validates data from the prover. The Verifier Module 60 uses the hash of the baseline configuration, saved in the ledger to verify the device integrity of the prover. Measurement data such as current, voltage, and interpacket arrival time are also collected from the various Cyber Grid Guard devices through IEC 61850 standard protocols such as GOOSE and SV. Data validation is carried out using statistical baselines on these measurements. Windows of statistical baselines are compared to the previous time window.

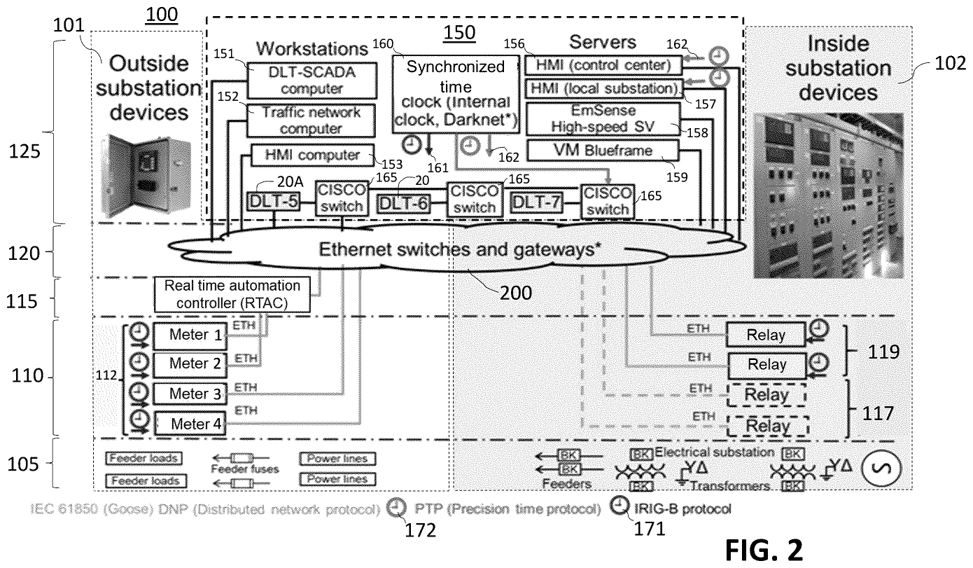

FIG. 2 illustrates a logic architecture 100 implemented in a Cyber Grid Guard attestation framework 10 of FIG. 1 including the architecture of the communication network and devices used therein. As shown in FIG. 2, the Cyber Grid Guard system is used to verify integrity of outside substation devices 101 and inside substation devices 102. At a physical network level 105, the monitored source devices at the outside substation 101 from which data is collected includes feeder loads, feeder fuses and power lines; while monitored source devices at the inside substation 102 from which data is collected include power sources, transformers, breaker devices, feeders, electrical substations, etc. At a next level is a protection and metering network level 110 which include, at the outside substation 101, devices such as power meters 112, and, at the inside substation 102, devices such as feeder relays 119, and transformer differential devices relays 117. The next automation level 115 includes an RTU or RTAC. Wired or wireless communication channels connect these protection and metering devices to an access network 120 that includes an Ethernet-based data communications network of routers, switches and gateways 200. Atop level of the network hierarchy is a control level 125 consisting of a control center 150 within which hardware and software modules and DLT nodes 20 of the Cyber Grid Guard attestation framework 10 of FIG. 1 is configured.

In an embodiment, one node, DLT-5, is the master node 20A and is used to configure and update the other two DLT nodes 20. It is the DLT-5 node 20A that is queried when performing attestation checks. In an exemplary embodiment, the control center includes three server machines, e.g., each with AMD Ryzen 9 3950X 16-core CPUs and 32 GB of RAM to function as DLT nodes, with each node hosting an HLF peer and orderer component.

Generally, the control center 150 of Cyber Grid Guard Attestation framework 10 includes computer workstations, servers and other devices that collect packets in the communications network 200 which come from the relays and smart meters and ultimately derive from sensors. These data include voltage and current data for the three phases associated with the relays 117. The data are analog when the devices generate the data but are then converted into digital form. The relays and meter devices package the digital data into packets to be sent over the communications network 200. In an embodiment, attestation framework 10 primarily uses IEC 61850 for the main protocol for SCADA network communications.

In an embodiment, control center 150 consists of computer workstations receiving packet data from the communications network 200, the computer workstations including but not limited to: a DLT-SCADA computer 151, a traffic network computer 152 and a human-machine interface (HMI) computer 155. Additional server devices of control center 150 receiving packet data include but are not limited to: HMI control center server 156, a local substation HMI server 157, an EmSense server 158 that emulates a high-resolution sensor for a power grid to provide SV raw data packets, and a BlueFrame asset discovery tool application programming interface (API) 159 for retrieving configurations and settings from the devices as part of the verifier module (VM) functionality. As shown in the control center configuration 150 of FIG. 2, an additional network clock and timing device 160 for distributing precise timing signals (timing data) via multiple output protocols, is provided. In an embodiment, network clocking and timing device 160 is a time-synchronized clock that can provide timed signals 161 according to an IRIG-B timing protocol 171 and can serve as a Precision Time Protocol (PTP) grandmaster clock 172 providing PTP time clock signals 162 to detect faults at an exact time and location. The robustness of using atomic oscillator grand master clocks for the DLT timestamping rather than GPS-based timing ensures the system is protected against GPS spoofing attacks, among other weaknesses related to GPS. Timing is provided by the system clock for the node on which it runs (e.g., master node DLT-5). The system clock is kept in sync using a Linux PTP client running on node DLT-5.

In an embodiment, the control center 150 is configured in a form of a Cyber Grid Guard “testbed” that implements several protocols:

One is the IEC 61850 protocol which is a level 2 protocol in which packets are broadcasted over the network. There are several major types of protocols in IEC 61850, including GOOSE and sampled values (SV). The GOOSE messages that the Cyber Grid Guard relays generate typically contain status information, such as the breaker state for a given relay. Modern relays are considered intelligent electronic devices (IEDs), i.e., they are computerized and have networking capability. These relays may also generate other information, including RMS voltage and current. The relays typically send the GOOSE data at lower frequencies than other types of data. Therefore, the time between packets that the relays broadcast is large. The SV packets typically contain raw voltage and current data. In contrast to the GOOSE messages, the Cyber Grid Guard relays send the SV packets at a very high frequency. These packets carry high-resolution data on the waveforms of voltages and currents associated with the relays.

As described, various devices in the Cyber Grid Guard attestation framework 10, such as relays and smart meters, produce the data as IEC 61850 packets. Relays used in the Cyber Grid Guard control center (e.g., testbed) are devices that allow a SCADA system to control breakers and gather sensor readings of voltage and current for all three phases. Modern power systems use AC electricity, which is sinusoidal in nature. The relays receive analog sensor data and sample the sensors at 20 kHz and internally compute RMS values based on the voltage and current. The relays broadcast these values via the network.

### Emsense (Emulated Sensor)

Because some of the devices in the Cyber Grid Guard control center (e.g., testbed) are limited in the type of IEC 61850 packets they produce, Cyber Grid Guard attestation framework 10 includes a device that produces IEC 61850 packets. As shown in FIG. 2, EmSense server 158 is a device that emulates a high-resolution sensor for a power grid. The device collects raw sensor and voltage data and packages the data in the form of IEC 61850 SV protocol packets that EmSense broadcasts on the network 200. In another mode, EmSense generates artificial sinusoidal data that appears as waveforms for voltage and current. EmSense has an internal algorithm for determining the period of a signal based on the data so that the period can be specified as a variable in the IEC 61850 packets. In one embodiment, the EmSense server device 158 collects raw sensor and voltage data that is derived from Oak Ridge National Laboratory's signature library. In an embodiment, one purpose of EmSense server 158 is to allow for experimentation with the Cyber Grid Guard architecture where a variety of sensors are represented along with their typical communication traffic. The EmSense device was developed in coordination with the software for receiving and processing the IEC 61850 packets. The receiving software includes a methodology for processing information of high velocity, variety, and volume.

In an implementation, whether configured as a control center 150 in FIG. 2 or as a testbed implementation, the following is assumed:

An asset inventory is first performed for all devices included in the Cyber Grid Guard control center 150 (testbed) architecture. Data on, or sent by, a compromised meter or relay device may or may not be affected by an attacker. Data trustworthiness must therefore be established for all source devices. Measurement and status data being sent from the device cannot be trusted unless the configuration artifact data is successfully verified by the verifier by matching its SHA hash to a known good baseline hash. The baseline configuration for devices has not been compromised. Known correct baseline configuration hashes are assumed to be uncompromised.

In an embodiment, the known correct baseline includes an initial configuration of hardware/software/firmware/settings for all devices. Device and network information cannot all be automatically collected for attestation. Some information may have to be collected and entered into the system manually and checked manually. Some data may only be collected by directly connecting to a device or by contacting the vendor. Firmware, software, configurations, settings, and tags are periodically checked against the baseline hashes in the Cyber Grid Guard DLT.

The attestation scheme does not include checking updates to device software/firmware before implementation in the applicable component. The native applications that run on the devices have not been compromised or tampered with and therefore provide a trustworthy baseline. The native applications act as the provers responding with attestation evidence (artifacts of configuration data) when the verifier sends the challenge query. The anomaly detection mechanism detects when a native application has been compromised. The mechanism uses the Cyber Grid Guard with DLT, which ensures the integrity of the data.

When configured as a Cyber Grid Guard testbed implementation, the following specific assumptions are made:

The timing system has an independent backup timing source, e.g., independent from DarkNet and/or the Center for Alternative Synchronization and Timing, that can be switched on when connectivity to this system is down. Timing must remain synchronized for all devices. Data integrity and message authentication are implemented using cryptographic protocols. A hash-based message authentication code is used for message authentication, and SHA256 is used for data integrity. In addition, HLF includes the transport layer security (TLS) protocol for communications security. The anomaly detection framework is configured to detect cyber security attacks, such as man-in-the-middle attacks and message spoofing.

In an embodiment, when configured as a testbed implementation, further prerequisites include:

DLT nodes 20 are located in the substation, metering infrastructure, and control center. As a minimum, three DLT nodes are required to obtain the full benefits of the HLF Raft consensus algorithm where “Raft” is the name attributed to the algorithm's attributes—i.e., reliable, replicated, redundant, and fault-tolerant. Communication paths are required to link the DLT nodes, e.g., via switching components 165.

Asset inventory will be conducted in an automated fashion where possible, with asset discovery tools that leverage vendor asset discovery systems. Integrated methods for asset discovery will be leveraged for IEC 61850. Automated vendor-specific asset discovery tools can be used. While the middleware software can be used to collect baseline data for the meters and relays, other tools and/or developed software may be used. Faults were detected for a subset of the data that was collected.

Assets not identified during the automated asset discovery process must be manually added to the system. Asset discovery and enumeration is required prior to implementation of the Cyber Grid Guard remote attestation and anomaly detection framework.

As Cyber Grid Guard can be deployed in an operational environment as a control center 150 and, in an embodiment, can be deployed in a testbed, e.g., to demonstrate the implementation of a DLT. Therefore, some cybersecurity devices that are typically deployed in operational environments may not be included in the testbed configuration, e.g., firewalls and demilitarized zones.

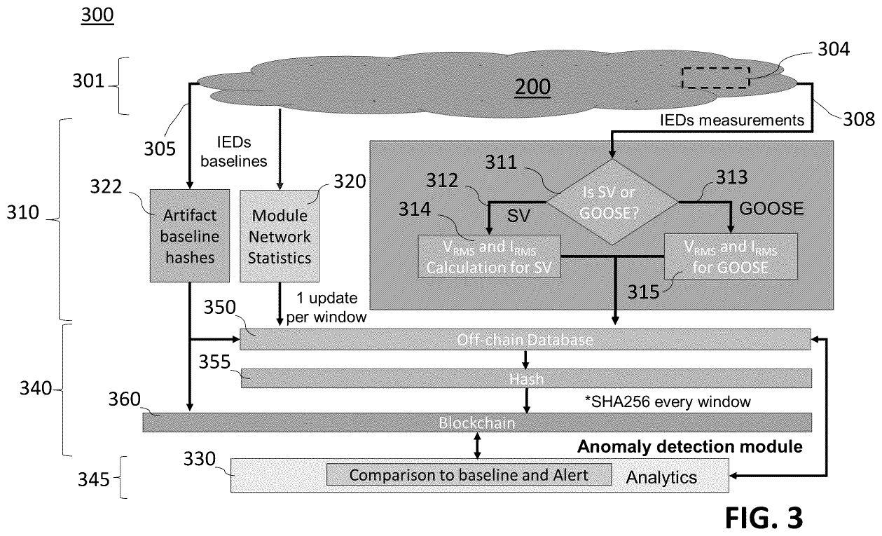

FIG. 3 shows the overall data flow 300 of the Cyber Grid Guard attestation framework 10 of FIG. 1. As shown in FIG. 3, in a data generation phase 301, network data from the network 200 are read by workstations and server devices at the control center 150 of FIG. 2 (e.g., or in the testbed) from a mirrored port(s) on the switch. These data include data from electrical substation-grid network with relays and meters including IEDs baselines data 305 and IED measurements data 308.

Data collection can occur at several locations in the framework. In an embodiment, the ledger master node, e.g., DLT-5 node 20 in FIG. 2, is connected to a switch mirroring port that captures all network traffic from the substation, metering infrastructure, and control center. Two categories of data are collected: IED measurements data and configuration (artifact) data. Data in the testbed are collected from the following sources: IEC 61850 packet data from GOOSE and SV messages from the high-speed high-fidelity sensors; device (e.g., IEDs, smart meters) artifacts, which includes configuration files; and network data.

As shown in FIG. 3, in an embodiment, all IEC 61850 data on the network are captured by first using the software program IEC 61850 Observer process 304. This observer process 304 is implemented using the libiec61850 library which is an open-source (e.g., GPLv3) implementation of an IEC 61850 client and server library implementing the protocols GOOSE and SV and detects any IEC 61850 GOOSE and SV packets on a configured network interface.

In an embodiment, packets are (1) received, formatted as JSON (JavaScript Object Notation), and output for other programs to use (GOOSE), or (2) received, aggregated based on the data set values using an RMS calculation, formatted as JSON, and then output (SV). An aggregation phase of the IEC 61850 observer for SVs allows the high-frequency output of samples (e.g., 1 kHz or more) by a device such as a real or simulated merging unit to be reduced to a manageable stream of JSON data, which can be consumed by downstream programs and stored. The observer also filters out duplicate packets that result from repeated or heartbeat transmissions. In the case of the SV packets, the observer contains functionality to aggregate the packets.

More particularly, a software module at a control center server that is responsible for data storage receives the JSON-formatted IEC 61850 packet data. These data are inserted into an off-chain data database 350 while simultaneously being hashed and stored in the blockchain ledger 360 at a DLT node 20. The off-chain data store is currently an open-source relational database management system (RDBMS), e.g., a PostgreSQL instance with a TimescaleDB extension. The Postgres SQL database provides support for JSON as a data type and provides efficient handling of time series data using TimescaleDB. This allows for flexibility when implementing and assessing schemas during development. Database tables (not shown) in the database are used for storing IEC 61850 GOOSE and SV packet data, network statistics, artifact data, anomalies and other events, hash window time stamps, and the keys used for accessing ledger data.

As shown in FIG. 3, in data ingestion and processing stage 310, all packets of IEC 61850 standard protocols sent by the protective relays, meters, and emulated high-speed sensors are ingested. For example, IED measurement data processing is performed to detect at 311 whether received IED measurement data is SV data packets 312 or GOOSE data packets 313. Statistics are calculated for each type of protocol-GOOSE, SV, and the Distributed Network Protocol 3 (DNP3). For example, a preprocessing module 314 receives 61850 SV data packets including raw voltage/current messages, filters and aggregates packets for a window of time to reduce data and to mitigate storage and performance issues, and computes respective VRMS and IRMS data for SV data packets 312; likewise, a preprocessing module 315 receives 61850 GOOSE data packets, filters out repeated and heartbeat messages, aggregates data to reduce and to mitigate storage and performance issues and computes V_{RMS} and I_{RMS} data for GOOSE data packets 313. These statistical values for the SV and GOOSE data measurements are stored in the off-chain database 350 for baseline comparison purposes. Further, every 1.0 min window of data is hashed, e.g., using SHA256 or similar hash function, and stored in the ledger. Hash update time windows greater than or less than 1 minute of data can be used (e.g., 1 hash update per window). A network statistics module 320 can further calculate general network statistics that are protocol-independent and stored for baseline comparison in the off-chain database 350. Finally, every device is queried to download its current configuration. Hashes of the network statistics and device configurations are computed and stored in the ledger.

In an embodiment, the types of measurement data that are collected in the Cyber Grid Guard attestation framework 10 include but are not limited to: 1) measurement data from Relays such as: Current magnitude and phase angle data; Voltage magnitude and phase angle data; a Real power; an Apparent power; a Power factor; a Frequency; a Time stamp. Under/over thresholds are calculated for current magnitude, voltage magnitude, and frequency; 2) measurement data from Meters (IEC 61850 GOOSE) such as: Current magnitude and phase angle data; Voltage magnitude and phase angle data; a Real power; an Apparent power; a Power factor; a Frequency; a Time stamp; 3) SV data from EmSense, such as Current or Voltage; 4) DNP3 meters data such as: Current magnitude and phase angle data; Voltage magnitude and phase angle data; a Real power; an Apparent power; a Power factor; a Frequency; a Time stamp. Under/over thresholds are calculated for current magnitude; and 5) measurement data from all devices on the network such as: an Interarrival packet time data; an Interarrival packet time by source. Under/over thresholds can be calculated for interarrival packet time. In an embodiment, computed statistics can include a minimum, mean, median, range, and standard deviation statistics. In an embodiment, these statistics can be computed over each measurement over 1.0 min. of data.

In an embodiment, the types of configuration (artifact) data that are collected in the Cyber Grid Guard attestation framework 10 include a baseline data that is created for each selected device, including the relay(s), smart meter(s), and network components. This baseline data creation occurs on initial system setup or when configuration changes are detected, and/or a Cyber Grid Guard system user manually establishes a new baseline. The raw baseline configuration data are stored off-chain, and a hash of the configuration data is stored in the blockchain ledger. The Cyber Grid Guard attestation framework triggers the baseline collection process at startup using software to collect the configuration data for each device. The raw data are stored in the off-chain database 350 and the hashed data are stored in the Cyber Grid Guard DLT blockchain 360. These configuration data are used for validation in checks when triggered by anomaly detection. Examples of configuration data include but are not limited to: 1) Protection schemes data, e.g., group setting; 2) Device configurations data; 3) Network settings data, e.g., port, frequency, data sent/received; 4) Tags for IEC 61850 protocol items and similar items for other protocols, e.g., registers for Modbus and identifiers in DNP3; 5) Firmware, program settings, and status data, e.g., reclose enabled/ground enabled, breaker status, long-term settings-GOOSE messages. These listed artifacts are non-limiting examples, and additional artifacts may be available. Configuration data availability is determined by the vendor and the vendor's proprietary software either directly or via vendor-specific software and tools for asset discovery and connectivity. In addition, software-developed tools may be used. In the Cyber Grid Guard architecture, HLF uses the Raft protocol.

Referring to FIG. 3, in data storage phase 340, the collected data are stored in the off-chain database 350 where they can be used for statistical and anomaly analysis conducted after an anomaly is detected using anomaly detection module 330. The data are also hashed at 355 and stored as a hash in a distributed ledger 360 using the Hyperledger Fabric (HLF) DLT platform. This addresses issues with storage of increasing amounts of data in arbitrary sizes by converting them to fixed-size hash values. Distributed Ledger 360 ensures recorded transactions between devices on a network by simultaneously putting the data in off-chain storage and the hashes in the ledger. HLF is a private-permissioned blockchain so only trusted users can store data in the ledger. Therefore, only device ledger nodes with permission can send data to the ledger. Devices (sensors connected to meters and relays) are not part of the permissioned system only the ledger nodes. Off-chain data integrity and sensor data are approximately 1 minute away from real-time due to making a window of data to hash. These can be checked on anomalous events detected on the network but can also be done at random intervals.

Device artifacts are collected using artifact baseline hash processing module 322 through vendor-specific APIs. Currently, the control center testbed uses BlueFrame API 159 of FIG. 2 for retrieving configurations and settings from the inside and outside sub-station devices. These file archive artifacts are further hashed at artifact baseline hash processing module 322 and added to the ledger 360. Sensor data and statuses are stored off-chain in off-chain database 350 for historical data retention and long-term analysis and forensics during an analytics phase 345. These data are validated using hashes stored in the ledger to ensure integrity.

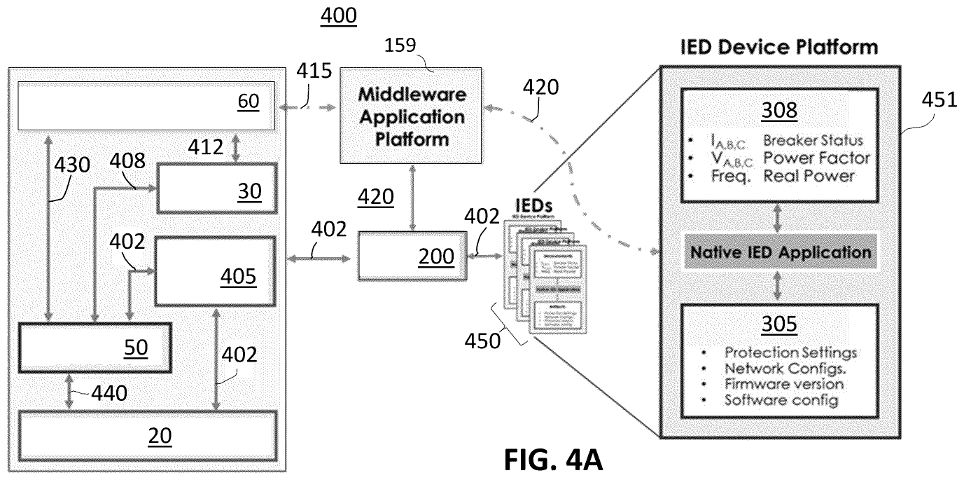

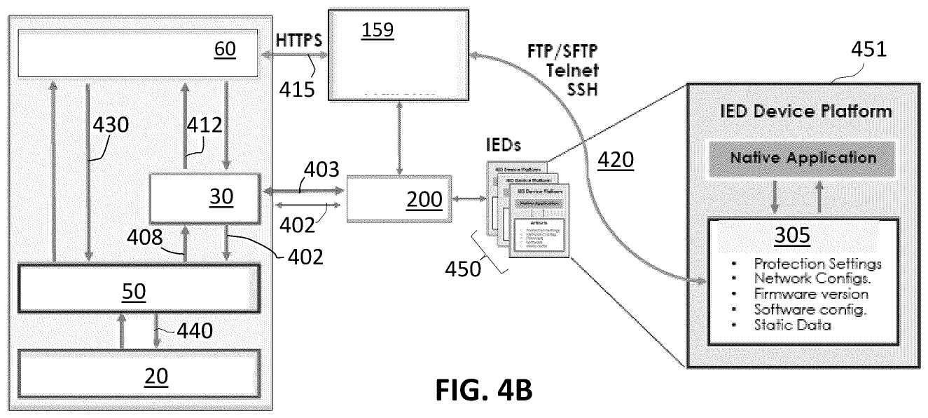

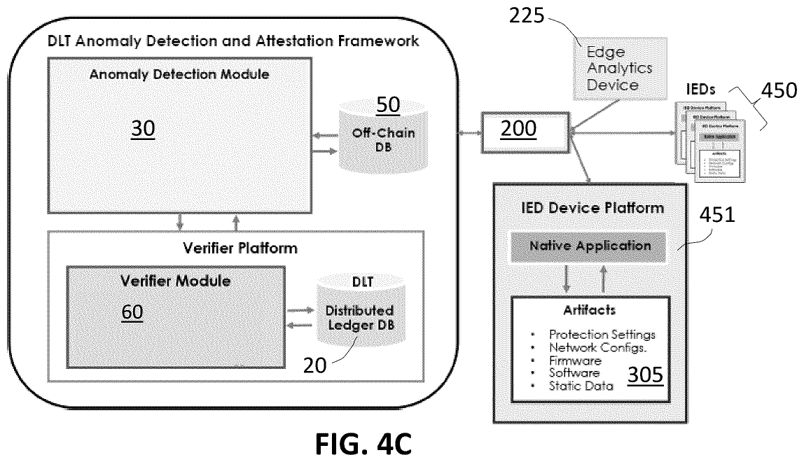

FIGS. 4A and 4B show respective high-level overviews of method 400 employed by Cyber Grid Guard attestation and anomaly detection framework 10 of FIG. 1.

In an embodiment shown in FIG. 4A, the Cyber Grid Guard attestation and anomaly detection framework 10 performs the method 400 in sequence as follows: A first step 402 involves the ingesting of data at a data ingestion processing module 405 which aggregates packet data, filters, analyzes and/or calculates the statistics and baseline thresholds for the network packet data, e.g., sensor data, GOOSE, SV, and configuration data, and then stores these in the off-chain database 50. In FIG. 4B, at 402, the anomaly detection module 30 receives the network packets and directly performs the ingestion processes to aggregate, filter, analyze and/or calculate the statistics and baseline thresholds for network packet data 403 received directedly from the network 200. In FIGS. 4A and 4B, at 408, the Anomaly Detection Module 30 checks statistical windows of data from the network and GOOSE/SV payloads against prior baseline threshold values stored at the off-chain database 50. Then, at 412, the Anomaly Detection Module 30 triggers the Verifier Module 60 when an anomalous event is detected. In response to the triggering at 412, the Verifier Module 60 initiates at 415 a remote attestation communication to the middleware application platform (e.g., BlueFrame API) 159 to validate the current configuration settings of one or more IEDs 450. For example, at 420, the Verifier Module 60 sends a message requesting, via a file transfer protocol, e.g., FTP/SFTP, SSH, Telnet protocols, a device measurement(s), configuration settings (artifacts), or both device measurements and configuration settings, from the various IEDs 450 across the multiple systems, e.g., substation, control enter, and metering infrastructure. FIG. 4A shows an example IED device platform 451 as comprising one or more of the IED measurement data 308 (e.g., current, voltage, frequency, breaker status, power factor, real power, etc.) and, as shown in FIGS. 4A, 4B, the IED baselines (artifacts) data 305 (e.g., protection settings, network configurations, firmware versions, software configurations, static data, etc.). Then, at 430, after the Verifier Module 60 retrieves the most recent configuration data from the devices via the middleware application 159, that data are hashed and compared to previously stored on-chain baseline device hashes in the HLF DLT 20. If the hashes do not match, then the IED device integrity has been compromised. At a further step 440, the off-chain data are continuously trust-anchored to the DLT 20 using SHA256. Off-chain data are also verified every time an anomalous event is detected using prior baseline data. In addition, the off-chain storage is reverified at random times.

FIG. 4C shows a DLT anomaly detection and attestation framework as in FIGS. 4A, 4B including anomaly detection module 30 interfaced with off-chain database 50 and verifier module, however configured with the verifier module 60 interfaced directly with DLT 20. The Network 200 include packet routing network devices, e.g., switches, routers, communication links and is further interfaced with edge analytics device 225 that run analytics functions including real-time processing tasks like Fast Fourier Transform (FFT) for frequency analysis, anomaly detection, and local aggregation of sensor data to reduce bandwidth and storage requirements.

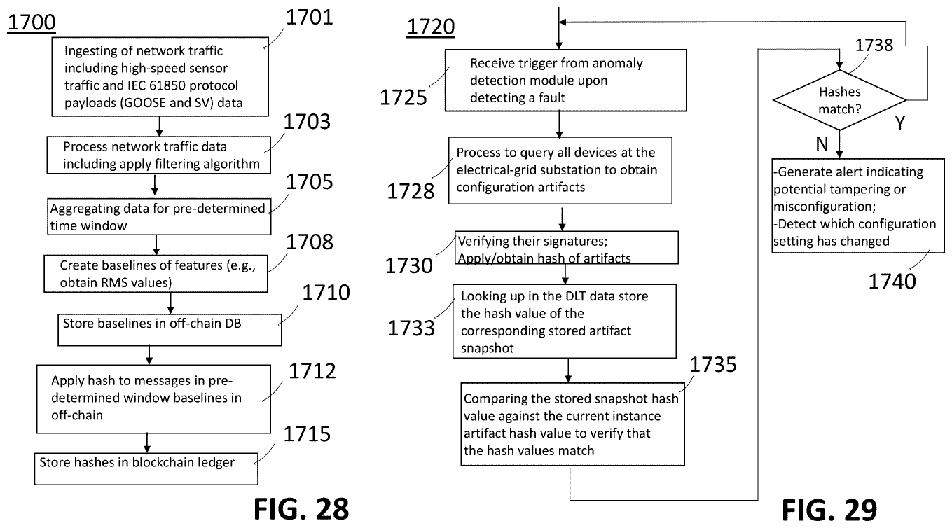

FIG. 28 depicts an overview of the software methods 1700 invoked at the anomaly detection module 60 including steps 1701 to ingest network traffic, e.g., at network switches, including high-speed sensor traffic and IEC 61850 protocol payloads (GOOSE and SV) data, the processing of the network traffic data including the applying of a filtering algorithm, e.g., to drop messages, and at 1705, the aggregating of data for a pre-determined time window, e.g., 1.0 minute, to obtain an RMS current or voltage measurement value and other features. Then, in 1708, methods are run to create a baseline of these data features and at 1710 these baseline features are stored as JSON messages in the off-chain datastore 50. Such features can include network statistics, e.g., the number of packets received per unit time. Further processing may include at 1712, the applying of a hash function to hash the messages in the 1-minute time window (e.g., 1 GB SHA256 per second) and the storing of the corresponding hashes at the blockchain DLT ledger data store in 1715. This may include taking a snapshot of the electrical grid substation device artifacts (e.g., device settings and configuration data), applying a hash to obtain a hash value of the artifacts and storing these in the DLT ledger data store.

FIG. 29 shows the attestation process as involving several key steps to ensure the integrity of configuration artifacts. As shown in FIG. 29, the attestation 1720 performed by the verifier module 60 includes a method step 1725 of receiving a trigger from the anomaly detection module 30 upon detection of an electrical fault event or cyber event or a network fault event (e.g., detecting an abnormal amount of packets lost per unit time), and responsively, at 1728, querying all devices at the electrical grid sub-station to obtain their configuration (artifacts), i.e., current instance of configuration data/settings such as the current configuration artifacts from relays, meters, RTUs or RTACs and other devices retrieved using the vendor-specific API, e.g., BlueFrame. Typical configuration artifacts obtained include protection relay settings (e.g., overcurrent protection parameters), network switch configurations (e.g., VLAN settings), and control logic of an RTAC or RTU, however these artifacts can also include firmware versions, protection scheme settings, and other device-specific parameters. Further steps 1730 may include verifying the artifact signatures to verify the integrity of the artifact data, e.g., according to a cryptographic protocol, and applying/obtaining a hash of the retrieved configuration artifact data, e.g., using the SHA256 algorithm, to create a unique fingerprint. A determination is then made as to whether the current instance configuration artifact hash value obtained by the verifier module for the grid devices matches the previously computed snapshot configuration baseline hash value stored in the ledger by comparing the current snapshot instance hash with the baseline hash stored in the distributed ledger. For example, at 1733, smart contract method steps are performed to look up the hash value of the corresponding artifact snapshot for that device(s) stored at the ledger, and at 1735, compare the snapshot (baseline) hash value stored in the distributed ledger against the current instance artifact hash value to verify that the hash values match. Continuing to 1738, FIG. 29, if the hashes match, the device(s) is(are) considered trustworthy and their integrity is verified. The process will then return to step 1725 to await until receipt of a new trigger responsive to a detected fault. If at 1738, it is determined that configuration artifact hash value stored in the ledger for the grid devices do not match the current instance configuration value obtained by the verifier module, then at 1740 an alert is triggered, indicating potential tampering or misconfiguration, potential cyber threat or equipment malfunction. A system operator can responsively be alerted for manual verification. Additionally, in response, a troubleshooting procedure may be invoked to determine which device configuration setting has changed. In an embodiment, the procedures of FIGS. 28 and 29 can be part of a “trust-anchoring” algorithm that can be periodically or randomly performed to verify the integrity of the device configuration(s) at the electric grid substation and the network device(s).

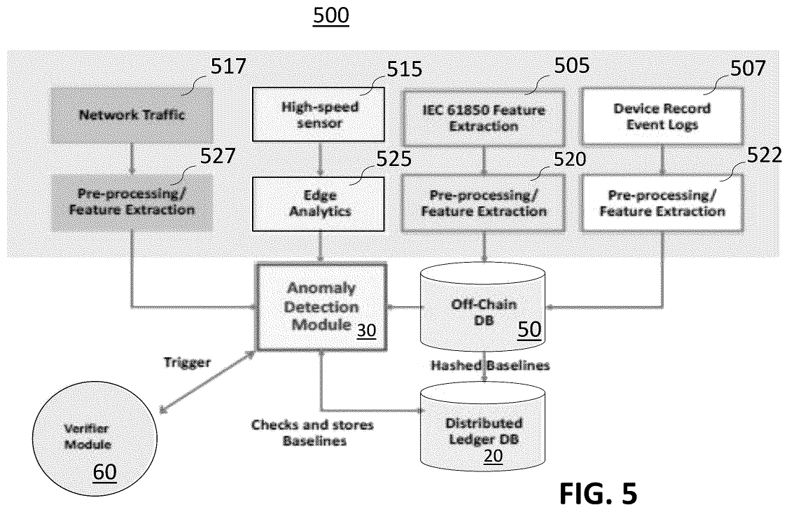

FIG. 5 shows a more detailed implementation of the data storage and DLT processing system 500 and data storage capability of the Cyber Grid Guard attestation framework 10 of FIG. 1. As shown in FIG. 5, anomaly detection module 30 receives data flow such as IEC 61850 feature extraction data 505, device record event logs 507, high-speed sensor data 515, and network traffic data 517. The IEC 61850 feature extraction data 505 includes the Generic Object-Oriented Substation Events (GOOSE) from Intelligent Electronic Devices (IEDs); the device record event logs data 507 include logs from protection relays and meters; the high-speed sensor data 515 includes data collected from high-speed sensors, which could be Phasor Measurement Units (PMUs) or sensors providing Sampled Values (SV) data, e.g., from EmSense or similar high-frequency sensors; and the network traffic data 517 includes raw data captured from network traffic within the system. In an embodiment, the received GOOSE data such as the IEC 61850 data 505 collected from relays, meters (GOOSE) and sampled values (SV) data from the EmSense device, etc., are each subject to pre-processing/and feature extraction steps 520 before storage at off-chain database 50. For example, feature extraction involves decoding the GOOSE messages, filtering relevant events, extracting timestamps, event types, and other relevant parameters for further analysis. The received device record event logs data 507 are subject to pre-processing/and feature extraction steps 522 before storage at off-chain database 50. In an embodiment, the feature extraction of the received device record event logs data 507 involves parsing log files, extracting relevant events, timestamps, event severity, device identifiers, and other metadata. Examples of event logs could be relay operation logs, high-speed fault records, and meter data logs. Further, received network traffic data 517 are subject to pre-processing/and feature extraction steps 527. In an embodiment, the feature extraction of the received network traffic data 517 involves capturing packets, filtering relevant data, and extracting packet-level features such as packet sizes, timing information, source/destination addresses, protocol types, and statistical measures (e.g., mean, variance) for anomaly detection. Further, in an embodiment, the received high-speed sensor data 515 is subject to edge analytics processing 525. In an embodiment, edge analytics processing 525 of high-speed sensor data 515 entails automatically performing analytical computation on the sensor data including real-time processing tasks like Fast Fourier Transform (FFT) for frequency analysis, anomaly detection, and local aggregation of sensor data to reduce bandwidth and storage requirements and to provide real-time insights and are stored in the off-chain database. Both network traffic and high-speed sensor data are also stored in the off-chain database. For each of the pre-processing/feature extraction and edge analytics steps, a user can set parameters on what information is or is not worth saving to the off-chain database 50. Further, such pre-processing and feature extraction steps can include aggregating packet data for a window of time, applying a hash, obtaining the baseline hash values and storing the hashed baselines in the DLT 20. Further pre-processing and feature extraction can entail obtaining artifact data, anomalies, and other events, hash window time stamps, and the keys used for accessing ledger data.

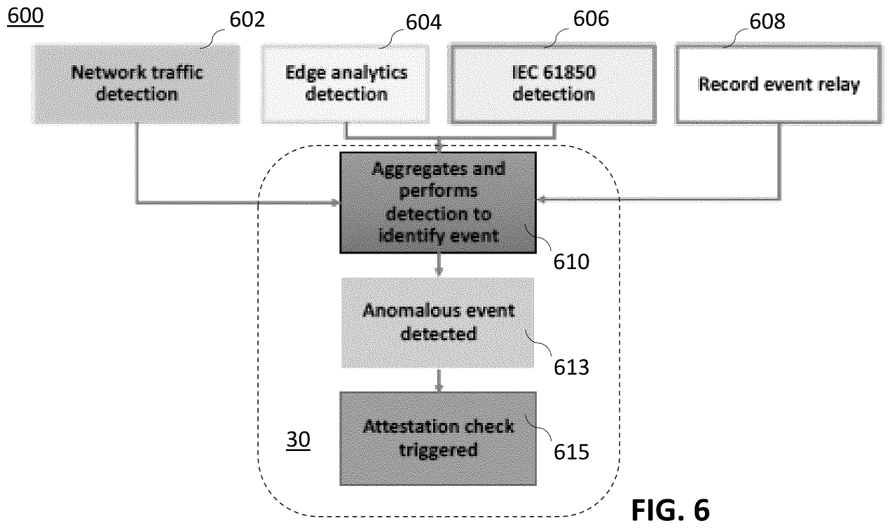

As shown in FIG. 6, the Network Traffic, High-speed Sensor, IEC 61850 Feature Extraction, Device Record Event Logs data all flow into the Anomaly Detection Module 30 after pre-processing and feature extraction. The Anomaly Detection Module 30 interfaces with both Off-Chain DB and Distributed Ledger DB and the Verifier Module 60 ensures data integrity and authenticity by interacting with the Anomaly Detection Module and databases. The verifier module 60 verifies the integrity and authenticity of the data by checking the data against stored baselines and is triggered by the anomaly detection module 30 if discrepancies are found. In one embodiment, the Blue Frame API checks the devices for new artifacts, which then makes the artifacts available for the Verifier Module software 60 to retrieve the artifacts. Herein, BlueFrame is configured to do this check every 1 min. In an alternate embodiment, the Verifier Module 60 is configured to bypass having to use BlueFrame API and can thus avoid a situation where if an artifact is changed in the middle of this cycle and an attestation check is already made, then the Verifier Module would not see the update until later when the API was updated and another check is made. This is therefore more efficient as the Verifier Module 60 can see the newest update.

The off-chain storage database 50 is the main storage for the raw measurement and configuration data. The blockchain ledger database 20 stores hashes of the off-chain data. This process of only storing hashes significantly reduces the amount of storage and speed required to support many devices on a network using DLT. High-speed sensors were simulated by replaying traffic on the network. The sensor data were baselined, and hashes were stored in the DLT. If necessary, the sensor data are filtered or aggregated. Waveform data are aggregated into RMS current/voltage data.

The storage of measurement data-which is constantly being transmitted at various frequencies and grows with the number of network devices-can present some potential issues which are addressed by first pre-processing the GOOSE and SV packet data received (or produced by an example electrical grid sub-station testbed), e.g., by aggregated and/or filtering, when possible, and then are hashed using static window periods ranging anywhere from between 0.5 sec and 1.0 min or greater. This allows arbitrary amounts of data within a specific window of time to be mapped to a fixed-size value. The hashing is done by combining the window data and using it as input to the SHA256 cryptographic hash function to get a 32-byte hash value.

The data storage and DLT processing system separates the packets it receives based on the IEC 61850 protocol. The current configuration for each type of IEC 61850 packet (GOOSE and SV) is a different source to create ledger keys. It then initializes a ledger data object by creating a key if necessary (and inserting the key in an off-chain database table for convenience) and initiates a hash window using the time stamp of the first packet it receives. Packet data are appended to the window until the end of the window period has been reached. At this point, the hash is created and sent to the blockchain ledger, and the window data are inserted into the off-chain database.

The window hash is created by joining all the JSON-formatted packet data in the window into a single, compact (no whitespace) UTF-8 byte-string, which is provided as input to a SHA256 hash function. The resulting hash value is converted into a hex string and used along with the time stamps of the first and last packets in the window as the arguments to an update transaction that is sent to the blockchain ledger. The Storage Module inserts all raw packet data within the window into the off-chain database in the appropriate table, along with the start/end time stamps of the hash window used in the update transaction.

There are several considerations related to determining the hash window size. One is the possibility of data being compromised in the period between data collection and hashing. This period starts when the data are received and ends with the transaction containing the window hash is successfully added to the blockchain ledger. Another consideration is ledger parameters such as the block creation time and smart contract implementation. Finally, computational performance, storage, and network latency constraints are additionally considered. In an embodiment, a 1 min. hash window period was selected that would allow enough data to be collected to reduce ledger storage and transaction processing concerns while also being short enough to reduce risk of compromise.

### Anomaly Detection Module

FIG. 6 illustrates the anomaly detection framework 600 implemented by anomaly detection module 30 of FIG. 1 that is responsible for detecting anomalies in the processed data. As mentioned, the Anomaly Detection Module 30 in the Cyber Grid Guard attestation framework 10 performs anomaly detection, based on the data stored in the off-chain network database and the hashes in the blockchain ledger. It functions to take features from the network traffic, high-speed sensors, IEC 61850 data and device logs to identify unusual patterns or behaviors that could indicate a security breach or system malfunction. For example, a first anomaly detection program 610 in anomaly detection module 30 performs aggregating of detected network traffic data 602, of detected edge analytics data 604, of detected IEC 61850 data 606 and record event relay data 608 and based on the aggregating identifies events about the aggregated data. A further software module 613 detects whether an anomalous event has been detected. If an anomalous event has been detected at 613, then an attestation check is triggered at 615 for receipt at the verifier module.

Referring to FIG. 2, the DLT-5 is designated the “master node” 20A because it is used to configure and update the other two DLT nodes. Each of the three nodes shown runs the “peer” and “orderer” components of HLF and communicate using the HLF gossip protocol. Data are sent as transactions to the DLT-5 node 20A, which currently serves as the primary entry point to the DLT network, but the data is shared with all DLT nodes. Similarly, the DLT-5 node is currently queried when performing attestation checks.

As mentioned concerning FIG. 1, the anomaly detection component of Cyber Grid Guard attestation framework 10 includes two software modules: the Network Anomaly Detection Module 33 and the Power System Anomalies Module 36 that uses the IEC 61850 data. In an embodiment, the Network Traffic Statistics Module 40 continuously queries network statistics. The network anomaly detection module 33 handles collecting network traffic via packet captures, calculating statistics, and then inserting them into an off-chain network statistics database table in the off-chain storage device 50. When one of the statistics has exceeded a threshold, a network anomaly event is inserted into the database and a device artifact attestation check is initiated.

Concerning the Power System Anomalies Detection Module 36, the API (e.g., BlueFrame) and other software are used to retrieve and store the artifacts from the protective relays, power meters, network devices, and IEDs. The anomaly detection software only stores a hash of the statistical baseline patterns in the blockchain ledger for comparison. These statistics are useful to establish a profile of behavior for the sensor data and network when running experiments under normal conditions. When the Cyber Grid Guard attestation framework 10 has collected new data into the database, these new data may be compared with the statistics to determine if the profile of the new data is like or significantly different from the established profile. A second software component collects and stores a window of data of a predetermined length, e.g., 1 minute of data, including multiple data streams to establish a statistical baseline for network communication and sensor patterns. While an aggregation window of 1 minute of received data is obtained, the window can range from between 0.5 minutes to 1.5 minutes, however, that window is configurable and windows of greater or lesser time range is contemplated.

When data or configuration/settings/parameters do not match the baseline, an alert is triggered for that device, indicating the new configuration hash and last known good configuration hash. The source of anomalous data is identified in terms of its IP address and/or MAC address.

A system operator can then manually verify if the change was authorized, but in alternative embodiments, this may be partially automated. Much of this determination on whether an anomaly has occurred is based on threshold checking of the data. When an attestation check event is triggered, the attestation scheme repeats the data verification step to compare the newly acquired data window with the stored baselines from the DLT. Anomalous data does not automatically imply that a cybersecurity compromise has occurred; it could be a result of a device failure or misconfiguration.

During verification, the data may be discarded unless an anomaly is detected, and then the data are stored for post-mortem analysis.

### HLF Implementation

As mentioned, HLF is an open-source permissioned DLT platform designed for general-purpose usage. It is blockchain-based with a modular architecture. The main roles and functions of HLF are split into components, which can be executed on one node in simple configurations or split across many nodes in larger networks. As a permissioned platform, HLF implements a system for authentication of users and authorization using policies. HLF also supports the use of smart contracts in addition to other features, such as private data for subsets of users.

Running an HLF network involves three main components. Peers are network nodes that maintain a copy of the ledger, which includes a world state database and the ledger blockchain. Data in the ledger are represented as key-value pairs. The world state database is a key-value database that keeps the current key-value pairs in the ledger to facilitate fast queries of recent data from the peer, and the blockchain is stored as a file. The world state database is configurable, with HLF supporting LevelDB key-value storage library as the default. CouchDB is another supported option, which—as a document database—allows for more advanced querying of ledger values stored as JSON. Peers can also be configured as validator nodes, playing a role in executing smart contract functions to validate transactions.

Orderers serve an important role in keeping the ledger data in a consistent state. Blocks of transactions are ordered and then sent to peers for final approval. Orderers use the Raft consensus protocol to agree on the transaction ordering and are also involved in performing authorization.

Certificate authorities (CAs) are the third main component. While optional, CAs are an important part of the public-key infrastructure that is integral to the functioning of the HLF platform in a production environment. Cryptographic material such as keys and certificates can be generated by various tools and deployed to nodes and users without using a CA, but this becomes burdensome to manage in larger networks. HLF is modular and provides support for other CA platforms in addition to its own CA component.

Being a permissioned DLT platform, users must authenticate to the platform before being able to use the ledger. Permissioned platforms are typically implemented in use cases in which a small number of organizations or groups control the DLT network and limit access to authorized users. HLF uses a concept of Membership Service Providers to represent the identities of users in the network. These identities may be supported by certificates from the CA(s). Policies are another important HLF concept that is used to define what users are authorized to do.

HLF supports the use of smart contracts to implement logic for handling transactions. Smart contracts are often referred to as chaincode in the context of HLF, which is the term used for the packaging and deployment of smart contracts in the network. HLF provides a software development kit for the development of smart contracts using a variety of popular programming languages, namely JavaScript, Java, and Go.

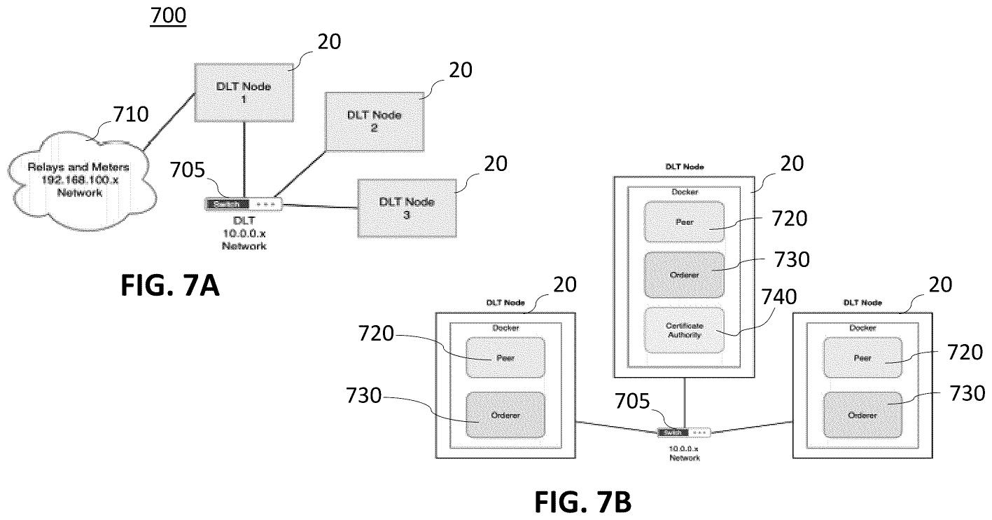

FIG. 7A shows an embodiment of an HLF DLT network configuration 700. When configured as a testbed, the HLF network includes three servers that each function as nodes within the HLF DLT network, e.g., DLT nodes 20. Three nodes were chosen to enable establishing a minimal setup that could handle at least one node failure and still function, however, additional nodes can be implemented. Each of the DLT nodes 20 has two Ethernet interfaces: One interface is configured for the 10.0.0.x network 705, which is used for HLF communication. One of the nodes had its second interface configured for another network (e.g., 192.168.100.x network) 710, which is used by the testbed relay and meter devices. This node is responsible for using that interface to receive data from the power devices for ingestion into the blockchain ledger. Ubuntu Linux 20.04.2 LTS is used as the operating system on each DLT node 20.

FIG. 7B shows the HLF Fabric network of FIG. 7A using “Docker” to execute HLF version 2.2 components on each node 20. These components include the peer 720, orderer 730, and CA 740. Each node 20 is configured to run an endorsing peer—responsible for validating and executing transactions—and an orderer 730. The ordering service uses Raft consensus. The use of three orderer nodes enables the system to tolerate at least one failure while maintaining a quorum of Raft nodes. In addition, one node runs the CA component 740, which is currently unused. The cryptographic material backing the ledger Membership Service Profile identities is generated manually and distributed to other nodes using SSH. The CA component 740 can be used for certificate management. Docker Swarm is used to deploy, run, and manage the components as Docker containers across the three nodes. Docker Swarm defines two types of nodes for managing and running containers. One of the DLT nodes is designated as the manager node, and the other two serve as worker nodes, with all three running containers. As shown in FIG. 2, DLT-5 is the master node 20A and DLT-6 and DLT-7 are the slave nodes 20. The configuration for all the HLF components was created using a Docker-Compose file in YAML format and used as the Docker Swarm service.

In an embodiment, scripts are implemented for automating various HLF network operations. The main script is responsible for starting or stopping the network. When starting, other scripts are called to handle initialization operations. These include deploying chaincode.

The HLF peer and orderer components are configured using the core.yaml file for the peer 720 and the orderer.yaml file for the orderer 730. The settings in these files are overridden in the Docker-Compose file using corresponding environment variables defined by the HLF Docker images. These settings include log levels, listener addresses and ports, and TLS configuration. The Docker-Compose configuration also designates data directories external to the containers for the peer and orderer components on each node. This allows for easier access to the ledger data on the host file system.

The world state database uses the default LevelDB. This could be configured as CouchDB in the future to take advantage of enhanced JSON document querying. Although Docker Swarm was chosen as the initial orchestration platform, the disclosed technologies can use Kubernetes as an alternative for the production environment.

In HLF, smart contracts define the functions used to send transactions to the ledger. These functions implement the logic involving how data are created, updated, or queried from the ledger and enforce constraints. Smart contracts can be grouped and deployed as chaincode. In an embodiment, the chaincode for the framework 10 implements a smart contract for each type of data. The MeasurementHashAudit smart contract handles measurement-related data, such as IEC 61850 GOOSE and SV packet data, and the ArtifactHashAudit smart contract handles device artifacts. Each ledger entry includes a key to uniquely identify and lookup the associated value, and the value itself. The key can be a single field, or it can be a composite key consisting of multiple fields. The value is always a data object in JSON format for the chaincode being used in the system.

The MeasurementHashAudit smart contract provides functions for storing and querying windows of hashed measurement data. At least three approaches can be used for implementing the measurement smart contract, each approach having various advantages and disadvantages based to implementation complexity, usage, and impact on the underlying world state database and storage.

Each entry includes a composite key with an ID field representing the measurement data source, and a time stamp representing the beginning of the measurement hashes it contains. The time stamp string contains the date and UTC time in ISO 8601 format, which provides chronological ordering of the strings when sorting.

The value is a data object that includes a string field containing a URI or description of the off-chain data source, the number of window hashes contained in the object, and an array of hashes containing all the hash windows for the period beginning at the key's time stamp. Several other fields describe the period represented by the key, including the period length and units. Each element of the hash window array contains a hash and the start and end time stamps for the measurement data. For example, a key-value entry in the ledger representing the 1 min hash windows of all IEC 61850 GOOSE packet data for a 24 h period beginning on Jan. 24, 2022, would consist of a composite key with the ID IEC61850 goose and the time stamp string 2022-01-24T00:00:00Z.

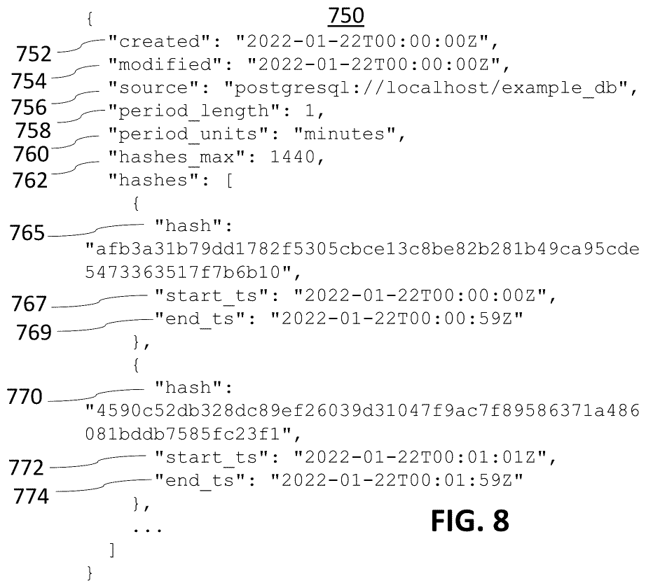

FIG. 8 shows an example corresponding DLT ledger data object 750 including the key:value entry pairs with example values provided for the following keys: a “created” key 752, a “modified” key 754, a “source” key 756, a “period_length” key 758, a “period_units” key 760, a “hashes_max” key 762, a composite hashes key that include a first hash key 765, a “start_ts” key 767, an “end_ts” key 769, and a further “hash” key 770, its “start_ts” key 772, and its “end_ts” key 774.

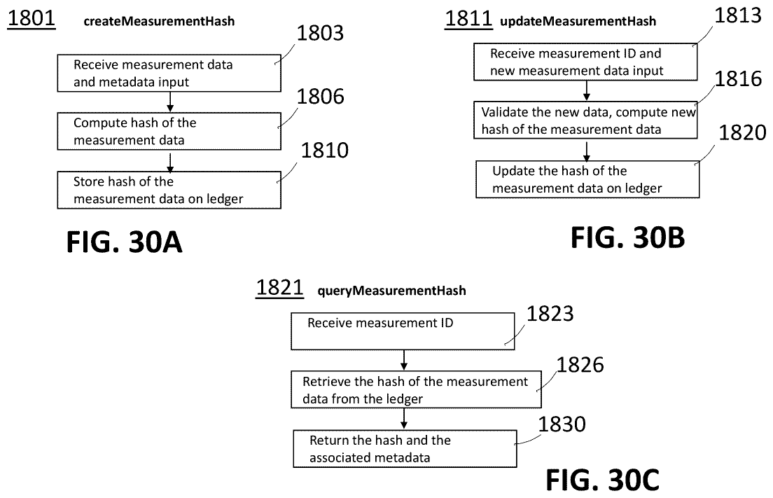

FIGS. 30A-30C shows methods and constraints for the MeasurementHashAudit smart contract according to an embodiment. The constraints refer to rules and conditions enforced by the smart contracts to ensure data integrity, security, and proper access control. In FIG. 30A, a first method is the createMeasurementHash 1801 that takes raw measurement data and creates a unique hash, ensuring that the measurement data is stored securely and immutably on the ledger. Method 1801 implements logic to receive measurement data and metadata input such as a measurement ID at 1803, computing a hash of the measurement data at 1806 and storing the hash on the ledger at 1810 for that measurement ID. In this method 1801, constraints ensure the trust anchor of the measurement data of the off-line database via the hash to blockchain ledger. As shown in FIG. 30B, a further updateMeasurementHash method 1811 allows updates to the measurement data while ensuring the integrity and consistency of the new data before updating the hash on the ledger. Method 1811 involves updating the measurement hash including step 1813 to receive a new measurement data input associated with a measurement ID associated with a prior measurement from a grid device. The new data is validated and a new hash of the new measurement data is created at 1816. Then, at 1820, the method updates a hash entry of the new measurement data on the ledger. In this method 1811, constraints ensure the new measurement data is added correctly to the ledger. As shown in FIG. 30C, a further queryMeasurementHash method 1821 provides a secure method to retrieve measurement hashes and associated metadata, ensuring only authorized access. Method 1821 involves updating the measurement hash including steps 1823 to receive a measurement ID associated with a prior measurement from a grid device. The method retrieves the hash of the measurement data from the ledger at 1826, and at 1830, the method returns the hash for that measurement ID and the associated metadata. In this method 1821, constraints ensure only authorized entities can query the measurement hash. For the MeasurementHashAudit smart contract, a uniqueness constraint is enforced such that each measurement hash must be unique; an integrity constraint is enforced such that the data used to create the hash must be validated for accuracy and consistency; and an access control constraint is enforced such that only authorized users can create, update, or query measurement hashes. It is understood that each blockchain node has its own self-signed certificate. These certificates which can also be given by a certificate authority provide source authenticity when adding new data to the ledger.

The ArtifactHashAudit smart contract provides functions for storing and querying device artifact data. Each entry includes a composite key with three fields: the ID of the artifact source, the ID of the artifact belonging to the source for which the hash was generated, and the ISO 8601-time stamp string.

The value is a data object containing a field that points to the off-chain data source for the artifact and another field for the hash value. For example, a device artifact representing an archive of device settings and configuration files provided by the BlueFrame API would have a key consisting of its source (device) ID 20411f6b-5d31-4a89-8427-1ee9c2c9afb1, the artifact ID 81b3e1784769a4ea0bf4e612dfe881e6, and the time stamp 2022-01-22T15:31:47.158354Z and the corresponding data object as follows:

```
  {
  “source”: “postgresql://localhost/example_db”,
  “hash”: “50ae4bd89152abec9ccfdccace49348a66e2610f6cae758789bee80228eab047”
}.
```

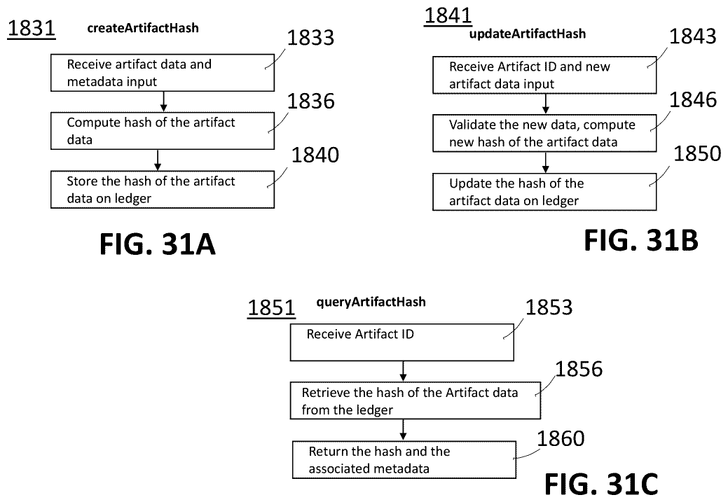

FIGS. 31A-31C shows a methods and constraints for the ArtifactHashAudit smart contract according to an embodiment. The constraints refer to rules and conditions enforced by the smart contracts to ensure data integrity, security, and proper access control. In FIG. 31A, a first method is the createArtifactHash 1831 implementing logic to receive artifact data and metadata input such as a device configuration setting in 1833, computing a hash of the artifact data at 1836 and storing the hash on the ledger at 1840 for that artifact data. In this method 1831, constraints ensure the uniqueness and immutability of the artifact hash at the blockchain ledger. As shown in FIG. 31B, a further updateArtifactHash method 1841 takes artifact data (e.g., configuration settings, raw and statistical measurements) and creates a unique hash, ensuring the data is stored immutably on the ledger. Method 1841 involves updating the artifact hash including steps 1843 to receive a new artifact data input associated with an artifact ID associated with a prior artifact stored for a grid device. The new data is validated and a new hash of the artifact data is created in 1846. Then, in 1850, the method updates the hash entry of the artifact data on the ledger. In this method 1841, constraints are enforced to ensure the new artifact data maintains consistency with the original artifact parameters. As shown in FIG. 31C, a further queryArtifactHash method 1851 allows secure retrieval of artifact hashes and associated metadata, with access restricted to authorized users. Method 1851 involves receiving an artifact ID associated with a grid device at 1853. The method retrieves the hash of the Artifact data from the ledger at 1856, and at 1860, the method returns the hash and the associated artifact and the associated metadata. In this method 1851, constraints are enforced to ensure only authorized entities can query the artifact hash. For the ArtifactHashAudit smart contract, an immutability constraint is enforced such that once a hash is created, it cannot be altered; a validation constraint is enforced such that all updates must be validated to ensure they comply with the original artifact parameters; and an access control constraint is enforced such that only authorized users can create, update, or query artifact hashes. Each blockchain node has its self-signed certificate. These certificates which can also be given by a certificate authority provide source authenticity when adding new data to the ledger.

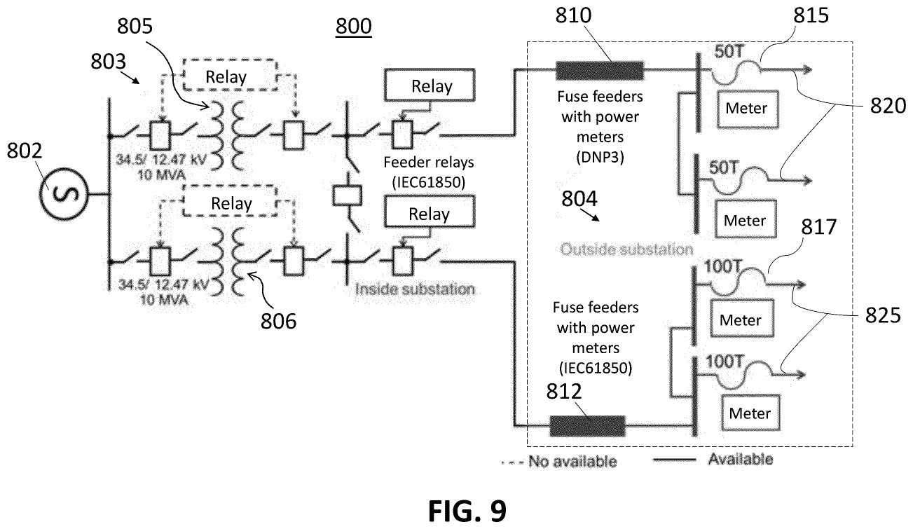

FIG. 9 depicts a one-line diagram of an example electrical substation-grid configuration 800. The example power system was based on an electrical substation having a power source 802 with two parallel-configured power transformers 805, 806 each of 10 MVA, and primary and secondary voltages of 34.5 kV and 12.47 kV. The electrical grid was a 12.47 kV power system that could be connected as a radial configuration. The source 802 feeds the primary side of first power transformer 805 via a serial connection of a first switch, breaker and second switch, and similarly feeds primary side of second power transformer 806 via a serial connection of a first switch, breaker and a second switch. The secondary side of power transformer 805 connects to a further serial connection of switch breakers and switches to feed first power line 810 of outside substation. Similarly, the secondary side of power transformer 806 connects to a further serial connection of switches, breakers and switches to feed second power line 812 of outside substation. Connected to the breakers on primary and secondary sides of each respective transformer 805, 806 is a respective transformer differential relay. The first power line 810 of the example electrical grid has power meters and fuses 815 on feeders connecting to a load 820 and the second power line 812 of the example electrical grid has power meters and fuses 817 on feeders connecting to a load 825. The inside substation devices were two protective feeder relays, and the outside substation devices were power meters.

The electrical substation was based on a sectionalized bus configuration. This arrangement is based on two single bus schemes, each tied together with bus sectionalizing breakers. The sectionalizing breakers may be operated normally open or closed, depending on system requirements. This electrical substation configuration allows the removal from the service a bus fault or breaker failure, to keep service with another breaker and/or bus if it is necessary. The sectionalized bus configuration allows a flexible operation, higher reliability than a single bus scheme, isolation of bus sections for maintenance, and the loss of only part of the substation for a breaker failure or a bus fault. The sectionalized bus configuration is shown as 803 in FIG. 9. The electrical grid was connected to the substation feeders through two breakers. The power meters or outside substation devices measured the phase current and phase-to-neutral voltages of fuse feeders. The electrical grid is shown as 804 in FIG. 9. The electrical substation and grid protection schemes were based on using overcurrent relays and fuses, respectively.

The electrical protection system of the substation and power grid was provided by two substation feeders that have two breakers 813, 816. Each substation feeder has a relay as a protective device. The respective breakers 813, 816 were connected to respective power lines 810, 812 and two power loads 820, 825 as shown in FIG. 9. The protection devices of the power loads were fuses, and the currents and voltages of these fuses were measured by the power meters. Based on the electrical substation-grid configuration 800 shown in FIG. 9, the radial power system configuration with outside substation devices and maximum load currents is shown in Table 1.

TABLE 1

| | | | Maximum | Type of |
|---|---|---|---|---|
| | Load | Power | load | Medium voltage |
| Power lines | feeders | Meters | currents (A) | fuse |
| Power line 1 | 1 | FIG. 2 Meter 1 | 35 | 50 T |
| | 2 | FIG. 2 Meter 2 | 35 | 50 T |
| Power line 2 | 3 | FIG. 2 Meter 3 | 70 | 100 T |
| | 4 | FIG. 2 Meter 4 | 70 | 100 T |

With respect to maximum load currents, these could be modified by setting different power loads.

### Electrical Substation-Grid Testbed

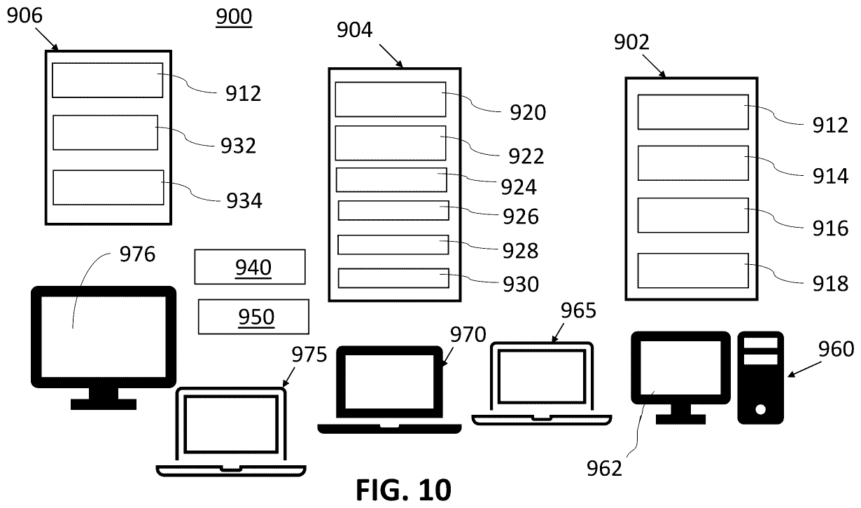

FIG. 10 depicts an electrical substation-grid “testbed” 900 interconnection of components that simulate operations of a control center 150 of FIG. 2 for the Cyber Grid Guard attestation framework. This testbed 900 provides a framework for determining the scalability of DLT data architecture and vulnerability assessment in an electrical substation with inside (protective relays) and outside (power meters) devices. The testbed 900 includes a real-time simulator rack 902 representing the electrical substation grid including the utility source, power transformers, breakers, power lines, bus, and loads; an inside/outside substation devices rack 904 representing the electrical protection and measurement system that was given by the protective relays (inside substation devices) and power meters (outside substation devices.); and a DLT communication rack 906 implementing the DLT. Additionally provided is the time synchronization system given by the timing synchronized sources and time clock displays, the communication system with ethernet switches, RTU or RTAC, and firewalls, and the Cyber Grid Guard framework with ethernet switches and DLT devices.

The testbed 900 generates different power system scenarios, such as normal operation and electrical fault events. The electrical substation-grid testbed 900 additionally performs the electrical fault and cyber event tests for inside (protective relays) and outside (power meters) devices with IEC 61850 and/or DNP3 protocols.

As shown in FIG. 10, the real-time simulator rack 902 of the electrical substation-grid testbed with DLT and inside/outside devices for cyber event detection includes but is not limited to, the following systems: a real-time simulator 912, 5 A amplifiers 914, a 1 A/120 V amplifier 916, and a power source 918. The inside/outside substation devices rack 904 of the electrical substation-grid testbed with DLT and inside/outside devices for cyber event detection include but is not limited to, the following systems: clock displays 920, protective relays 922, ethernet switch 924, power meters 926, RTU or RTAC 928, and other power meters 930. The DLT communication rack 906 of the of the electrical substation-grid testbed with DLT and inside/outside devices for cyber event detection includes but is not limited to the following systems: such as clock displays 921, an RTU or RTAC 932, and SCADA display screens 934. These components are connected to Ethernet switches 340 and distributed ledger technology (DLT) devices 350.

Additionally, the electrical substation-grid testbed 900 of FIG. 10 has four main workstations (computers) that are connected to the electrical-substation network of the testbed: the host computer 960, HMI computer 965, traffic network computer 970 and the DLT-SCADA computer 975 and event detection monitor 980. The host computer workstation 960 including real-time simulation monitor 962 is configured to supervise and run the real-time simulation tests with hardware in the loop and for generating the phase currents and phase to neutral voltages measured by the protective relays and power meters, and breaker pole states measured by the protective relays. Computer 960 is also configured to collect currents, voltages, breaker states from tests (e.g., MATLAB files). The HMI computer workstation 965 can set the protective relays and power meters. The HMI was also used to change relay settings during the event tests to determine the impact of the event time and collected data such as substation inside/outside device events data (e.g., COMTRADE files) at the electrical substation-grid testbed. The traffic network computer 970 is configured to collect network traffic data from inside and outside substation devices based on the IEC 61850 and DNP3 protocols. The DLT-SCADA computer workstation 975 and event detection monitor 976 is configured to collect the measurements from substation inside (protective relays) and outside (power meters) devices and detected cyber events from the DLT devices. Additionally, a BlueFrame computer (not shown) is provided that is configured for retrieving and storing the artifacts from IEDs such as power meters and protective relays. For the Cyber Grid Guard framework, it is necessary during the simulations to be able to collect and record relevant data. These data can be used for later analysis. Since the devices, e.g., protective relays, power meters, that produce the data are synchronized with the master clock, the time stamps associated with the data are correlated. Several computers are used in this collection of data. The electrical substation-grid testbed includes six computers located at desks and racks. In addition, in the testbed 900 of FIG. 10 are the control center HMI workstation, local HMI workstation, BlueFrame workstation, and EmSense high-speed SV servers/computers.

Table 2 is a table depicting the commercial software applications used to build the electrical substation-grid testbed of FIG. 10.

TABLE 2

| Commercial | |
|---|---|
| Software | Applications |
| MATLAB/ | To create the electrical substation-grid model |
| Simulink | |
| RT-LAB | To create the RT-LAB project configuration |
| | To run the simulations |
| AcSELerator | To set the protective relays with IEC 61850 |
| Quickset | To set the power meters with IEC 61850 |
| | To set the power meters with DNP |
| | To communicate with the protective relays |
| | and power meters |
| | To use HMI of protective relays and power meters |
| AcSELerator | To create the IEC 61850 CID files for the feeder relays |
| Architect | To create the IEC 61850 CID files for the power meters |
| | To download the IEC 61850 CID files into the |
| | protective relays |
| | To download the IEC 61850 CID files into the power |
| | meters |
| AcSELerator | To create the architecture for the RTU or RTAC and |
| RTAC | power meters |
| | To communicate and download the configuration to |
| | RTU or RTAC |
| | To create the configuration for the RTU or RTAC with |
| | SCADA |
| AcSELerator | To create the SCADA project for the electrical |
| Diagram Builder | substation-grid |
| Wireshark | To collect and verify the GOOSE messages f |
| | rom relays and power meters |
| | To collect and verify the DNP messages from power |
| | meters |
| Blue Frame | To retrieve and store the artifacts from |
| | protective relays and power meters |
| Synchrowave | To plot and analyze the COMTRADE events from |
| | protective relays and power meters |

This electrical substation-grid testbed 900 can be implemented by using a real-time simulator with hardware-in-the-loop. In one embodiment, as shown in Table 2, the MATLAB/Simulink® software (available from The MathWorks, Inc.) is used to create the electrical substation-grid testbed model. The real-time (RT)-LAB software that enables Simulink models to interact with the real world in real-time is used to create the RT-LAB project configuration and integrate the electrical substation-grid testbed model with the real-time simulator. Also, the RT-LAB software is used to run the power system simulation tests. The AcSELerator Quickset software (available from SEL, Inc.) provides the capability for configuring, commissioning, and managing devices for power system protection, control, metering, and monitoring is used to set the protective relays and power meters. These devices were connected to the HMI computer 965 to measure currents and voltages from protective relays and power meters. The IEC 61850 protocol transmits the GOOSE messages that were configured with the GOOSE data set of protective relays and power meters before being installed. The protective relays and power meters were set with CID files to create the GOOSE messages. The software AcSELerator Architect software (available from SEL, Inc.) provides the capability to configure and document the IEC 61850 communications settings between devices based on creating and downloading the IEC 61850 CID files for the protective relays and power meters. Other power meters had DNP3 instead of the IEC 61850 (GOOSE) protocol. These power meters were connected to an RTU or RTAC. The RTAC polled data from the power meters with DNP3 and transmitted the measurements from the power meters.

Areal-time (RT)-LAB project implementation for the electrical substation-grid testbed 900 of FIG. 10 included wiring protective relays and power meters with a real-time simulator. The MATLAB/Simulink® and RT-LAB software were used to create the RT-LAB project configuration. This RT-LAB project configuration was implemented in the host computer that deployed the RT-LAB project configuration in the target computer (real-time simulator) and ran the simulations with the hardware-in-the-loop.

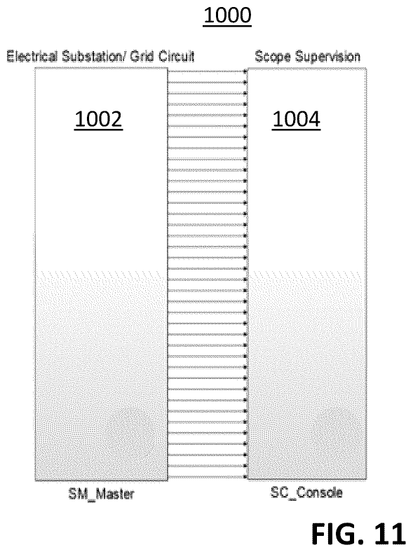

FIG. 11 shows the RT-LAB project configuration 1000 created using two subsystems, one master block (SM_Master) 1002 with the simulated electrical substation-grid testbed circuit, and another block 1004 to perform the SC_Console. The SC_Console block 1004 checked the simulation tests. The phase currents and phase to neutral voltages from the protective relays and power meters, and the breaker pole states of the electrical substation feeders, were collected during the simulation from the SC_Console block 1004. FIG. 11 depicts an embodiment of the SM_Master block 1002, e.g., electrical substation/grid circuit and SC_Console subsystem block 1004, e.g., scope supervision of the RT-LAB project configuration.

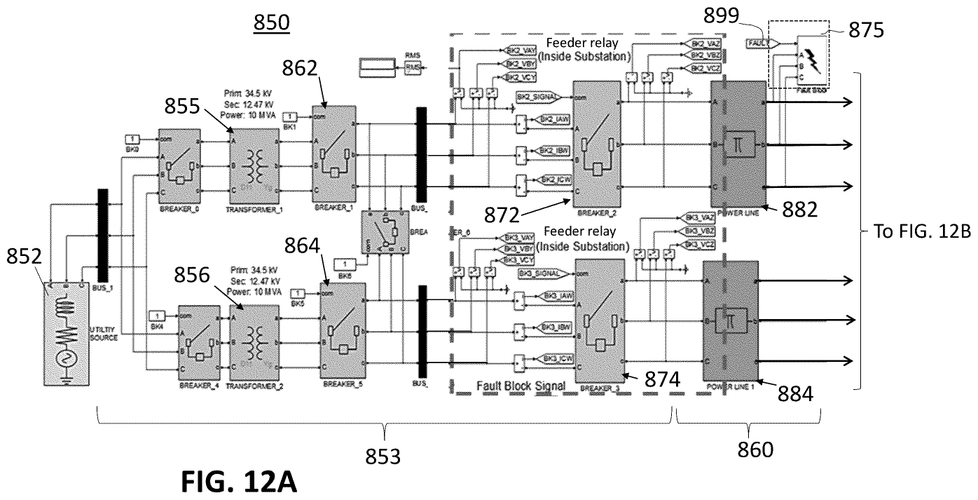

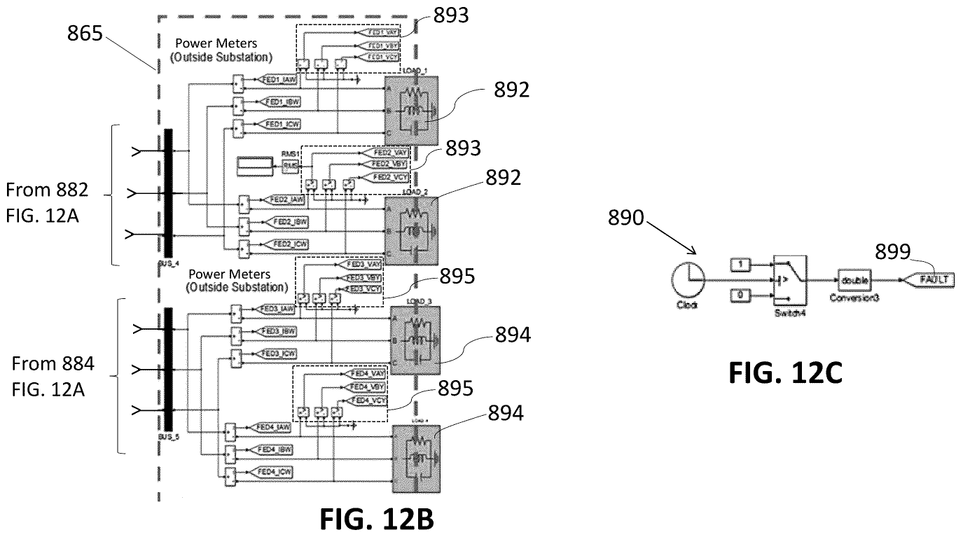

In an embodiment, an exemplary electrical substation-grid testbed circuit was set inside the SM_Master block 1002 shown in FIG. 11. The electrical substation-grid testbed system 850 shown in FIGS. 12A-12C was implemented using an exemplary sectionalized bus configuration corresponding to the electrical substation-grid testbed power system 800 shown in FIG. 9 including the utility source, electrical substation, power lines, and power load feeders. As shown in FIG. 12 A, the electrical substation-grid testbed system 850 includes in FIG. 12A, a power source 852, electrical substation circuitry 853, and simulated power lines 860; and in FIG. 12B, includes power load feeders circuitry 865; and in FIG. 12C includes fault signal generator circuitry 890. In FIG. 12A, the electrical substation circuitry 853 implemented two 34.5/12.47 kV power transformers 855, 856 of 10 MVA connected in parallel. The electrical substation had two breaker feeders 862, 864 of 12.47 kV that were controlled by two protective relays-in-the-loop 872, 874; therefore, the A, B, and C phase currents and phase to neutral voltages were collected from the breaker feeder locations. Each breaker feeder was connected to a radial power grid, with two 12.47 kV power lines 882, 884 connected to respective power loads 892, 894. These power lines 882, 84 were simulated with a three-phase π (pi) section line block. The protection devices of the power loads were medium voltage fuses. One power line 882 had two power loads with 50 T fuses, and the other power line 884 had two power loads with 100 T fuses. The A, B, and C phase currents and phase to neutral voltages for the 50 and 100 T fuses were measured with the power meters 893 and power meters 895, respectively, based on the one-line diagram of electrical substation-grid testbed in FIG. 9.

In FIG. 12A, the protective relays 872, 874 measured the A, B, and C phase currents and phase to neutral voltages from the breaker feeder locations, as well as the breaker trip/close signals. In FIG. 12B, the power meters 893 and power meters 895 measured the A, B, and C phase currents and phase to neutral voltages from the fuse feeders. A fault block 875 shown in FIG. 12A is configurable to set the single line-to-ground (SLG), line-to-line ground (LLG), line-to-line (LL), three line-to-ground (3LG), and three-line (3L) faults at any location of the electrical substation-grid 850. The fault block 875 is triggered by an external fault signal 899 generated by a fault block circuit 890 shown in FIG. 12C that set the time to start the fault state in the fault block 875.

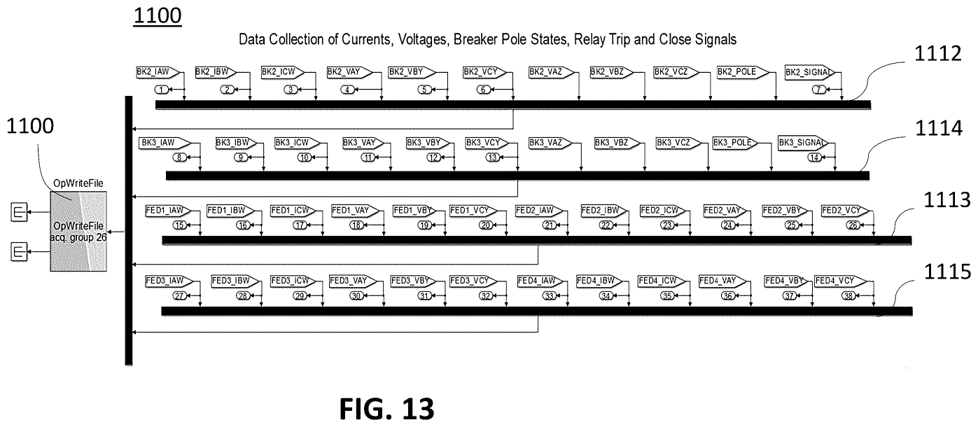

FIG. 13 shows, inside the SM_Master block 1002 of FIG. 11, the data acquisition circuit 1100 was set with the OpWrite File block 1105 that recorded the data 1112, 1114 from the respective protective relays 872, 874 and data 1113, 1115 from the respective power meters 893, 895 during a simulation.

For the electrical substation breaker feeders provided by the protective relays-in-the-loop 872, 874, the A, B, and C phase primary currents, phase to neutral voltages, and breaker trip signals were collected as respective data 1112, 1114 shown FIG. 13. For the power load feeders provided by the power meters-in-the-loop, the A, B, and C phase primary currents and phase to neutral voltages were collected as respective data 1113, 1115 shown in FIG. 13.

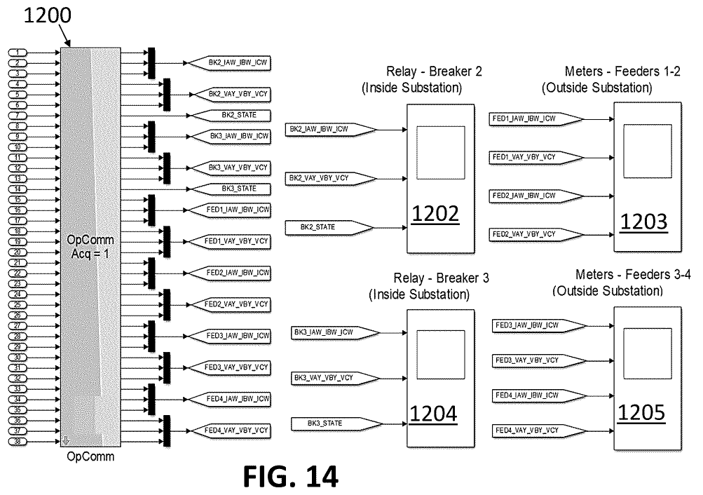

FIG. 14 shows inside the SC_console subsystem 1004 of FIG. 11, an OpComm block and scopes that are set to supervise a simulation. As shown in FIG. 14, the OpComm block 1200 is connected to scopes 1202, 1204 to measure voltages, currents and breaker states for the respective inside substation protective relays-in-the-loop and is connected to scopes 1203, 1205 to measure voltages, currents and breaker states for the respective power meters-in-the-loop 893, 895.

In FIG. 14, the Opcomm block 1200 is configured to collect the signals simulated from the SM_Master subsystem 1002 of FIG. 11A. The scopes were open during the simulations to supervise the experiments. The scopes 1202, 1204 for the electrical substation breaker feeders provided by the protective relays-in-the-loop measured the A, B, and C phase primary currents, phase-to-neutral voltages, and breaker pole state signals. The scopes 1203, 1205 for the power load feeders provided by the power meters-in-the-loop measured the A, B, and C phase primary currents and phase-to-neutral voltages.

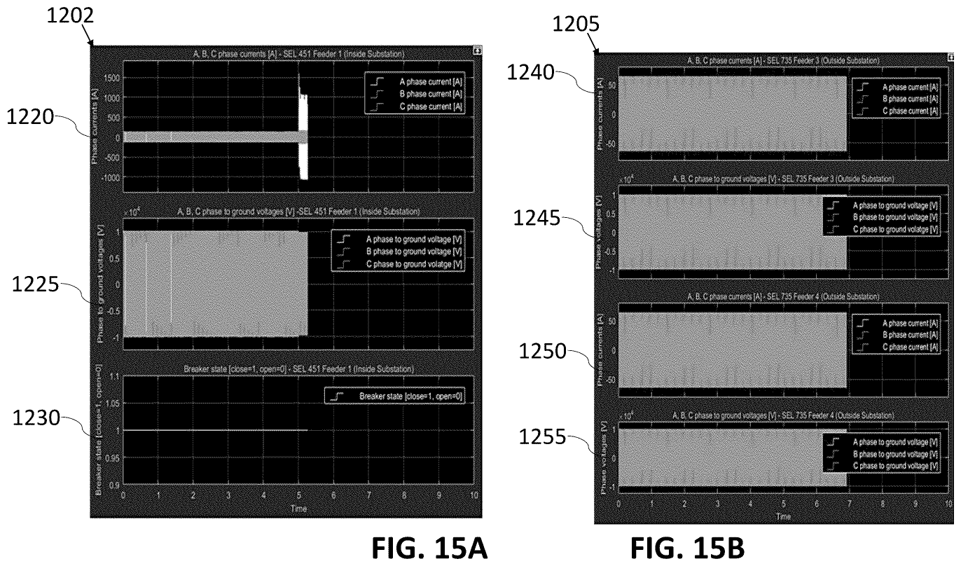

FIGS. 15A-15B show the signals measured during tan exemplary simulation of a SLG electrical fault located at the end of the power line 882 of FIG. 12A for one feeder protective relay 872 and two power meters 893.

In FIG. 15A a first scope 1202 measured the signals from the protective relay that was connected to the faulted power line 882 provided by fault block 875. As shown in FIG. 15B, a further scope 1205 measured the signals from the power meters that were wired at power load feeders of the non-faulted power line 884. Then, the signals for the relays and power meters could be supervised during the simulation. In this case, the A, B, and C phase primary currents shown as scope display 1220 in FIG. 15A, phase to neutral voltages shown as scope display 1225 in FIG. 15A, and breaker pole state signals shown as scope display 1230 in FIG. 15A for the SE-451 protective relay was measured at a faulted power line 882. In addition, the A, B, and C phase primary currents shown as scope displays 1240, 1250 shown in FIG. 15B and phase to neutral voltages shown as scope displays 1245, 1255 for the power meters were measured at a non-faulted power line 884.

Measured Feature Categories and Total Measurements with DLT

In the electrical substation-grid testbed 850 of FIGS. 12A-12C, the Cyber Grid Guard framework measured the GOOSE messages of two protective relays 872, 874 and two power meters 895. The measurements from these devices were given by analog signals, digital signals, and time stamps. The measurements that represent the analog signals were given by numerical values that could be estimated based on computed statistic values (e.g., minimum, maximum, mean, range, and standard deviation) such as A, B, and C phase voltages and currents, frequency, and real and reactive power. However, the digital signals were given by Boolean values and represent the breaker states (e.g., closed or open), and time stamp signals were not estimated based on statistic values. Table 3 provides characteristics of the Cyber Grid Guard attestation framework at the electrical substation-grid testbed 850 and lists exemplary measurements that were collected.

TABLE 3

| Network-retrieved data | | | | | |
|---|---|---|---|---|---|
| | Meter | | | | |
| | GOOSE data | | | | |
| Protective relay | set points | | | | Device- |
| GOOSE data set | with | | | | retrieved |
| points with | statistics, | | | Data | data |
| statistics, R_{GDPS} | M_{GDPS} and no | EmSense SV | All devices | statistics | IED |
| and no statistics, | statistics*, | data set points, | on network, | Statistic | category |
| R_{GDNPS} | M_{GDNPS} | E_{SVDPS} | I_{PTS} | values, Sᵥ | settings |
| QTY: 16, 2* | QTY: 16, 1* | QTY: 6 | QTY: 2 | QTY: 5 | QTY: 14 |
| I_{A,B,C} mag. (3) | I_{A,B,C} mag. (3) | Phase A, B, C | Interarrival | Minimum | Automation |
| I_{A,B,C} angle (3) | I_{A,B,C} angle | RMS current (3) | packet time | Maximum | Port |
| V_{A,B,C} | (3) | Phase A, B, C | (1) | Mean | Group |
| magnitude(3) | V_{A,B,C} | RMS voltage (3) | Interarrival | Range | Breaker |
| V_{A,B,C} angle (3) | magnitude(3) | | packet time | Standard | Monitor |
| W power (1) | V_{A,B,C} angle | | by source (1) | deviation | Alias |
| Var power (1) | (3) | | | | Global |
| Power factor (1) | W power (1) | | | | Report |
| Frequency (1) | Var power (1) | | | | Protection |
| Breaker state*(1) | Power factor | | | | Front panel |
| Time stamp*(1) | (1) | | | | Output |
| | Frequency (1) | | | | Bay control |
| | Time | | | | Notes |
| | stamp*(1) | | | | DNP |

Where QTY is quantity. The measured feature categories (MFC) are calculated according to equation (1), as follows:

$$MFC = {S}_{V} ( {R}_{GDPS} + {M}_{GDPS} + {E}_{SVDP} + {I}_{PTS} ) + [ {R}_{GDPNS} + {M}_{GDPNS} ] , \qquad ( 1 )$$

where MFC are the measured feature categories, R_{GDPS} is the relay (GOOSE) data set points with statistics, M_{GDPS} is the meter (GOOSE) data set points with statistics, E_{SVDP} is the EmSense (SV) data set points, I_{PT} is the number of interarrival packet times with statistics, R_{GDPNS} is the relay GOOSE data set points with no statistics, and M_{GDPNS} is the meter GOOSE data set points with no statistics. The total number of measurements in the Cyber Grid Guard framework depends on the number of power meters and protective relays connected to the Cyber Grid Guard framework. The total measurements in the Cyber Grid Guard framework were calculated by multiplying Eq. (1) by the number of meters and relays using the GOOSE messages at the electrical substation-grid testbed. The total measurements at the Cyber Grid Guard framework are given by Eq. (2),

$$TM = {S}_{V} ( {N}_{R} [ {R}_{GDPS} + {E}_{SVDP} ] + {N}_{M} [ {M}_{GDPS} + {E}_{SVDP} ] + {I}_{PTS} ) + [ ( {N}_{R} \times {R}_{GDPNS} ) + ( {N}_{M} \times {M}_{GDPNS} ) ] , \qquad ( 2 )$$

where TM is the total measurements, N_{R} is the number of relays, and N_{M} is the number of meters.

From Table 3 and Eqs. (1) and (2),
MFC=5×(16+16+6+2)+[2+1]=5×(40)+[3]=203 (measured feature categories) where MFC=measured feature categories;
R_{GDPS}=relay GOOSE data set points with statistics (16) and R_{GDPNS}=relay GOOSE data set points with no statistics (2)
M_{GDPS}=meter GOOSE data set points with statistics (16) and M_{GDPNS}=meter GOOSE data set points with no statistics (1)
E_{SVDP}=Essene SV data set points (6); I_{PTS}=number of interarrival packet times (2); and S_{V}=5 statistics values (e.g., minimum, maximum, mean, range, and standard deviation)

The total measurements T_{M} at the Cyber Grid Guard framework will depend on the measured feature categories and number of meters N_{M} and relays N_{R}. Then, the total measurement at the Cyber Grid Guard framework is calculated by Eq. (2).

$$TM = {S}_{V} ( {N}_{R} [ {R}_{GDPS} + {E}_{SVDP} ] + {N}_{M} [ {M}_{GDPS} + {E}_{SVDP} ] + {I}_{PTS} ) + [ ( {N}_{R} \times {R}_{GDPNS} ) + ( {N}_{M} \times {M}_{GDPNS} ) ]$$

$$\begin{matrix}TM = 5 \times ( \{ 2 \times 16 \} + \{ 2 \times 16 \} + \{ 2 \times 6 \} + \{ 2 \times 6 \} + 2 ) + [ ( 2 \times 2 ) + ( 2 \times 1 ) ] \\ TM = 5 \times ( 32 + 32 + 12 + 12 + 2 ) + [ 4 + 2 ] = 5 \times ( 90 ) + [ 6 ] = 456 ( total measurements )\end{matrix}$$

### Procedure to Set Threshold Values to Detect Electrical Faults

In an embodiment, an anomaly detection algorithm detects the electrical faults at the power system implemented in the electrical substation-grid testbed based on finding the maximum and minimum RMS current magnitudes to detect the electrical faults and verifying possible maximum load RMS current. The maximum RMS current magnitude was calculated by finding the minimum electrical fault phase RMS current magnitude. Then, the SLG, LLG, LL, and 3LG electrical faults were set at the testbed to measure all electrical fault phase RMS currents and find the minimum electrical fault phase RMS current magnitude. The minimum RMS current magnitude was calculated by implementing a power flow simulation at the electrical substation-grid testbed to detect the maximum load RMS current. Then, the threshold value to detect the electrical faults was selected with a value between the “1.5×Irms max load” that represents the possible maximum RMS phase current at normal operation, and the “Irms min faultt” that represents the minimum electrical fault RMS phase current.

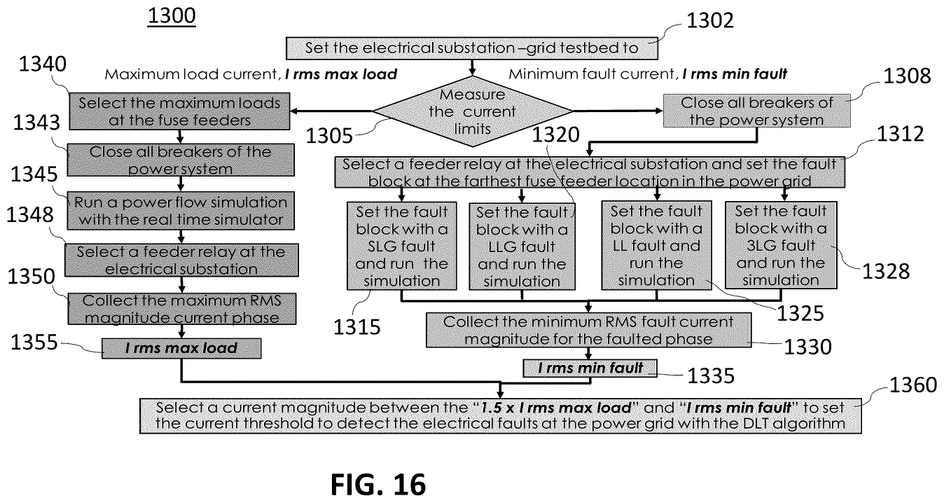

FIG. 16 depicts a flowchart of method 1300 for anomaly detection, in particular, to calculate the RMS phase current magnitude threshold to set the DLT algorithm for detecting the electrical fault events at the electrical substation-grid testbed for the feeder relays. As shown at 1302, in an embodiment, the electrical substation-grid testbed of FIGS. 12A-12C is configured to perform anomaly detection events, e.g., by programming it to either detect a minimum fault current or detecting a maximum load current. At 1305, the method makes a real-time measurement to measure the limits of current flowing to a load in the simulation of the electrical substation grid. To configure the electrical substation grid to detect a minimum fault current (e.g., 1 rms min fault) the processing continues at 1308 which generates a command to close all the breakers of the power system. The process continues to 1312 to select a feeder relay at the electrical substation grid and set the fault block at the farther fuse feeder location in the power grid. Then there is performed one or more fault setting procedures including, at 1315, the setting of the fault block 875 with a SLG fault and at 1330 running one or more simulations to collect the minimum RMS fault current magnitude for the faulted phase (hereinafter “I rms min fault”). The minimum RMS fault current magnitude for the simulated SLG fault is then set at 1335. Similar steps can be run to set a minimum current detection limit for LLG faults, LL faults and 3LG faults. For example, after selecting the feeder relay at the electrical substation-grid testbed, step 1320 can be performed to set the fault block 875 with a LLG fault and then run one or more simulations at 1330 to collect the I rms min fault current magnitude for the faulted phase. Further, after selecting the feeder relay at the electrical substation grid, step 1325 can be performed to set the fault block 875 with a LL fault and then run one or more simulations at 1330 to collect the I rms min fault current magnitude for the faulted phase. Similarly, after selecting the feeder relay at the electrical substation grid, step 1328 can be performed to set the fault block 875 with a 3LG fault and then run one or more simulations at 1330 to collect the I rms min fault current magnitude for the faulted phase.

Returning to 1305, the measuring of the current limits further includes processes for detecting a maximum load current (hereinafter “I rms max load”). Continuing at 1340, the method selects the maximum loads at the fuse feeders of the electrical substation-grid testbed, closes all the breakers of the power system at 1343, and runs a power flow simulation with the real time simulator at 1345. Then continuing at 1348, the method selects a feeder relay at the electrical substation-grid and at 1350 collects a maximum RMS magnitude current phase. Then, the method sets a IRMS maximum load magnitude value for the simulated maximum load current.at 1355.

Continuing to 1360, once the I rms min fault current magnitude is determined at 1335 for each type of fault, and once the IRMS maximum load magnitude is determined at 1355, the method proceeds to 1360 where a current magnitude threshold is set for detecting an electrical fault at the power grid for the DLT algorithm. In an embodiment, the current magnitude for setting a current magnitude fault is computed as a magnitude value between 1.5×“I rms max load” and “I rms min fault”. IT is this set current threshold value that is used to detect the electrical faults at the power grid with the DLT algorithm. In an example, based on the electrical substation-grid testbed, the protective relays located at the electrical substation feeders were considered with a maximum load current of 100 A, and the minimum electrical fault current was 751 A (SLG electrical fault). Then, from FIG. 16, the selected RMS current magnitude threshold was 200 A to set the DLT algorithm for detecting the electrical fault events at the substation feeder relays.

### Experiments and Testing

To test the framework 10, a multilayered testbed was developed that emulated various interconnected systems, and subsystems of the power grid. The testbed includes four main subsystems: a substation, metering infrastructure, a control center, and an underlying hardware-in-the-loop real-time simulation of power electronics and power systems, e.g., such as a substation circuit emulated model RT-LAB (available from OpalRT Technologies, Inc.) which produces realistic electrical measurements to support creating realistic baseline models.

Experiments conducted with grid devices such as relays, meters, and Human Machine Interfaces (HMIs) have demonstrated data verification and device attestation on a scaled-down testbed that mimics real-world grid architectures and topologies. To determine how well the Cyber Grid Guard attestation framework 10 of FIG. 1 can collect and validate data and how it responds to various events, multiple experiments were performed within the testbed under various circumstances including normal conditions, cyber events, and electrical fault events. These main categories of events were selected because of their relevance to power systems. To run the experiments on the testbed, the Opal RT hardware-in-the-loop must run a specific simulation of the power system appropriate to each experiment.

In general, the purpose of these experiments is to achieve the attestation of the testbed emulating power grid simulations, which can be grouped into categories including (1) normal load events, (2) cyber events, (3) electrical fault events, and (4) co-occurring cyber and electrical fault events. The cyber events were defined as an attempt by an engineer to set a bad setting in a protective relay by mistake or an attempt by a malicious entity to set an undesirable setting. This may be intentional or unintentional and negatively impacts the electrical infrastructure network or system. Both intentional and unintentional cyber events could have the same results despite their different nature. The experiments demonstrate that the DLT devices can capture the relevant data of the power system from the protective relays inside the electrical substation and the power meters outside the electrical substation. The attestation and data verification could be evaluated satisfactorily by using the Cyber Grid Guard framework.

Experiments 1.a and 1.b: The first category was normal load events and included two experiments: Experiment 1.a was performed with a normal MATLAB/Simulink model of the electrical substation grid and metering infrastructure with no electrical faults simulated. Experiment 1.b was essentially the same but incorporated the EmSense device, which broadcast IEC 61850 SV packets in addition to the GOOSE packets sent by the testbed devices. The experiment was created to provide more variety in the network traffic, especially since high-fidelity traffic is required.

Experiments 2.a and 2.b: The second category was cyber events and included two experiments involving normal load simulations at the electrical substation-grid testbed that were subjected to various cyber events and phenomena on the power grid and communication network. Experiment 2.a involved a command injection to change the current transformer ratio setting, which is a non-desired situation, of a protective relay located inside the electrical substation. Experiment 2.b involved a command injection to open a feeder breaker, which is another non-desired situation, with a protective relay inside the electrical substation.

Experiments 3.a, 3.b, 3.c, and 3.d: The third category was electrical fault events and involved various types of electrical faults at the electrical substation-grid testbed. These electrical faults were performed at the load feeders where the power meters were located. Then, the protective relays located inside the electrical substation implemented backup protection devices by clearing these electrical faults. All the electrical faults were introduced at 50 s into simulations of 100 s. These experiments were performed for a SLG (experiment 3.a), LL (experiment 3.b), LLG (experiment 3.c) and 3LG (experiment 3.d) electrical faults.

Experiment 4.a: The fourth category was cyber and electrical fault events and involved the possibility that a cyber event can occur in tandem with an electrical fault. This experiment addressed a situation and response of a protective relay to a single line to ground electrical fault and an added cyber event. Experiment 4.a included a cyber event of a command injection to change the current transformer ratio setting on the protective relay with an added naturally occurring SLG electrical fault.

All experiments were run at the electrical substation-grid testbed, e.g., real-time simulator with hardware-in-the-loop. The experiments were run with the RT-LAB software that integrates the MATLAB/Simulink® libraries. The experiments have a time step of 50 μs to provide a real-time simulation for the power grid, and each simulation was set at 100 s for consistency and to compare the data. Table 4 summarizes the experiments performed with the Cyber Grid Guard attestation framework 10.

TABLE 4

| Category | Exp. ID | Description | Simulation | Added activities |
|---|---|---|---|---|
| 1. Normal | 1.a | Normal conditions with no | Model with load | N/A |
| load events | | electrical faults or cyber | power flow | |
| | | events | | |
| | 1.b | Normal conditions with | Model with load | EmSense running and |
| | | EmSense and no electrical | power flow | sending IEC 61850 SV |
| | | faults or cyber events | | packets |
| 2. Cyber | 2.a | Normal load condition | Model with load | Command injection |
| events | | with no electrical faults or | power flow | (change of the current |
| | | cyber events and change of | | transformer ratio setting |
| | | setting variables | | on the protective relay) |
| | 2.b | Normal load condition | Model with load | Command injection |
| | | with no electrical faults or | power flow | (open breaker) |
| | | cyber events and opening a | | |
| | | breaker | | |
| 3. | 3.a | The SLG electrical fault | Model with the | N/A |
| Electrical | | occurs at 50 s into the | SLG electrical | |
| fault events | | experiment | fault (at 50 s) | |
| | 3.b | The LL electrical fault | Model with the | N/A |
| | | occurs at 50 s into the | LL electrical fault | |
| | | experiment | (at 50 s) | |
| | 3.c | The LLG electrical fault | Model with the | N/A |
| | | occurs at 50 s into the | LLG electrical | |
| | | experiment | fault | |
| | | | (at 50 s) | |
| | 3.d | The 3LG electrical fault | Model with the | N/A |
| | | occurs at 50 s into the | 3LG electrical | |
| | | experiment | fault (at 50 s) | |
| 4. Cyber | 4.a | Both an electrical fault and | Model with the | Command injection |
| and | | a cyber event occur at 100 | SLG electrical | (change of the current |
| electrical | | s into the simulation | fault (at 50 s) | transformer ratio setting |
| fault events | | | | on the protective relay |
| | | | | with a SLG electrical |
| | | | | fault) |

As mentioned with respect to FIG. 5, the Anomaly Detection Module 30 triggers the Verifier Module 60 to query the BlueFrame computer to retrieve and store the artifacts from IEDs such as protective relays and smart meters to the ledger via device standard protocols and HTTPS. API requests from the Verifier Module stored the configuration artifacts and network traffic in the ledger for anomaly detection and post-mortem forensic analysis.

By using the Anomaly Detection and Verifier Modules of FIG. 5, electrical faults and cyber events could be detected and differentiated. A SLG electrical fault was executed in the simulation that used a denial-of-service cyber event. Additional fine-tuning of parameters can be performed to learn baselines for detecting multiclass events to differentiate the type of anomaly and to determine if the devices are still trustworthy after the events.

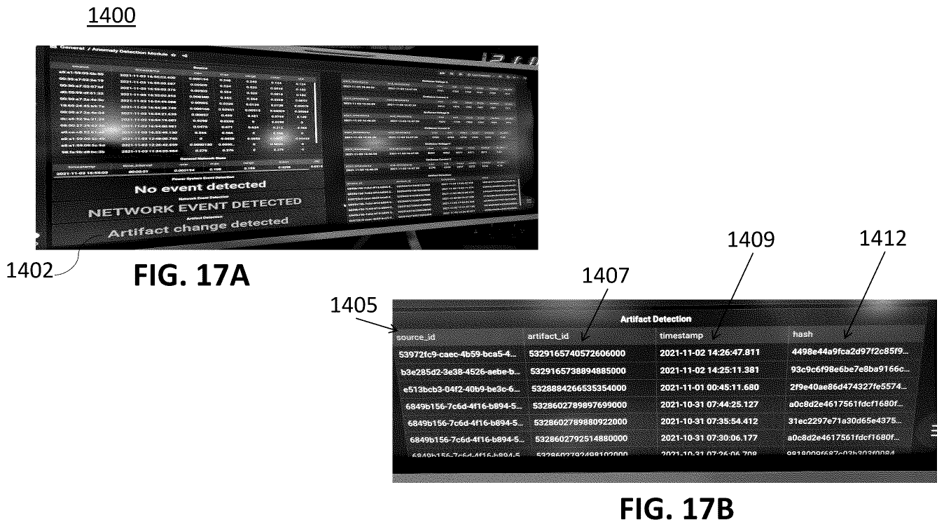

FIG. 17A shows an example DLT screen display 1400 used to detect the power system fault events and artifact changes at the electrical substation-grid testbed. In the example DLT screen display 1400 of FIG. 17A, there is shown the display message 1402 presented in response to detecting a network event in the form of an artifact change. FIG. 17B shows the hashes for the configuration files on the devices at the electrical substation grid testbed.

In an embodiment, the example DLT screen 1400 shown in FIG. 17B depicts the detection of an artifact and provides a display including a listing of sources, e.g., source_id 1405, a corresponding artifact id 1407, a corresponding timestamp 1409 and a hash value of the configuration 1412.

In the example DLT screen 1400 shown in FIG. 17B, the hashes 1412 for the configuration files are displayed for the devices at the electrical substation grid testbed. Data were collected from protective relays and power meters that were verified against stored hashed baselines in the blockchain for trustworthiness. If a different hash is detected, then an alert 1402 is triggered through the graphical interface shown in FIG. 17A. The specific setting change can be identified in post-mortem analysis by reviewing the off-chain storage for the last known correct baseline configuration file.

In the Cyber Grid Guard testbed, the power system events based on electrical faults were detected by using the hashes and storing the statistical baselines for RMS values of the phase A, B and C currents of the protective relays over a specified time window. The experiment was conducted with the DLT devices that measured the A, B, and C phase RMS current magnitudes to attempt to detect electrical faults by comparing the pickup RMS current magnitude versus the A, B, and C phase RMS current magnitudes for the feeder protective relay located at the electrical substation. In the DLT algorithm, to detect the power system events for the electrical faults, the DLT pickup RMS current magnitude was set to not trip the fault event detection at the maximum load current and trip the fault event detection at minimum electrical fault current, represented by Eqs. (3) and (4).

$${I}_{DLT - fault event pickup} > {I}_{rms max load} , \qquad ( 3 )$$

$${I}_{DLT - fault event pickup} \geq {I}_{rms min fault} , \qquad ( 4 )$$

where I_{DLT-fault event pickup} is the value greater than the maximum load current I_{rms max load} and minimum electrical fault current I_{rms min fault} for the feeder protective relay located at the electrical substation. The electrical fault event detection was not tripped for the maximum load RMS current magnitude and was tripped for the phase RMS current magnitude greater or equal to the minimum electrical fault current magnitude.

### Data Collection

In embodiments, for all illustrative example experiments and simulations, data are collected for analysis. The sources of these data include the PCAP file generated from Wireshark, MATLAB file of simulation, record event from the relays, and database entries from the DLT for comparison. The results of illustrative example experiments are divided into two main sets: results of experiments under various conditions that include normal, cyber event, and electrical fault scenarios; and results on performance testing of the Cyber Grid Guard framework.

### Experimental Results Under Various Conditions

Example experiments were conducted and the raw data and the data stored in the ledger were collected. Also, each experiment was analyzed to understand the behavior of the voltage and current and why the behavior occurs.

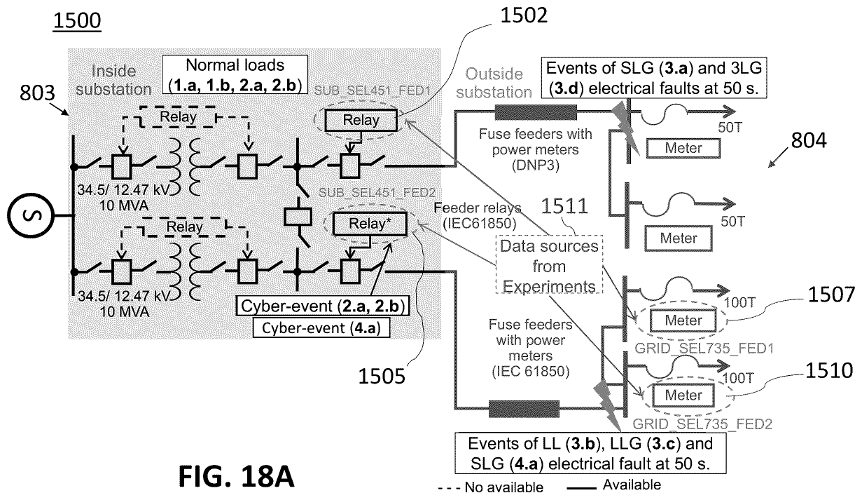

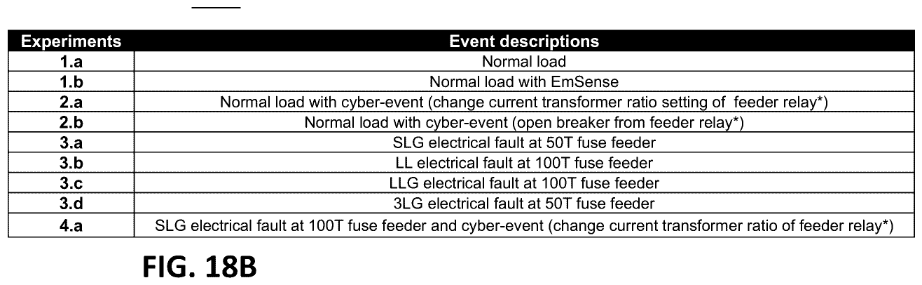

FIG. 18A shows the electrical substation-grid diagram of the testbed (“grid testbed”) 1500 that corresponds to the one-line diagram of an electrical substation-grid testbed power system 900 shown in FIG. 9 which depicts a sectionalized bus configuration 803 having an electrical grid 804 connected to the substation feeders through two protective breakers 1502, 1505 respectively labeled “SUB_SEL451_FED1” and “SUB_SEL451_FED2”. The power meters 1507, 1510 or outside substation devices measured the phase current and phase-to-neutral voltages of fuse feeders. FIG. 18B shows example event descriptions 1550 for the conducted experiments. As shown in FIG. 18A, the results of these experiments are data 1511 associated with four devices in the power system: the two protective feeder relays 1502, 1505 and the two power meters 1507, 1510.

As shown in the table 1515, FIG. 18B, experiments labeled 1.a, 1.b, 2.a and 2.b are cyber events represented by a normal load; experiments 3.a, 3.b, 3.c and 3.d represent experiments with electrical fault events; and experiment 4.a represents an experiment with a combined cyber and electrical fault event. In an embodiment the cyber events were applied to relay 1505, and the electrical faults (SLG, LL, LLG and 3LG) were applied at 50 s in the 50 and 100 T fuse feeder. The cyber events can represent an operator that modified the breaker status and/or the relay settings by mistake.

Experiments with Normal Load Events

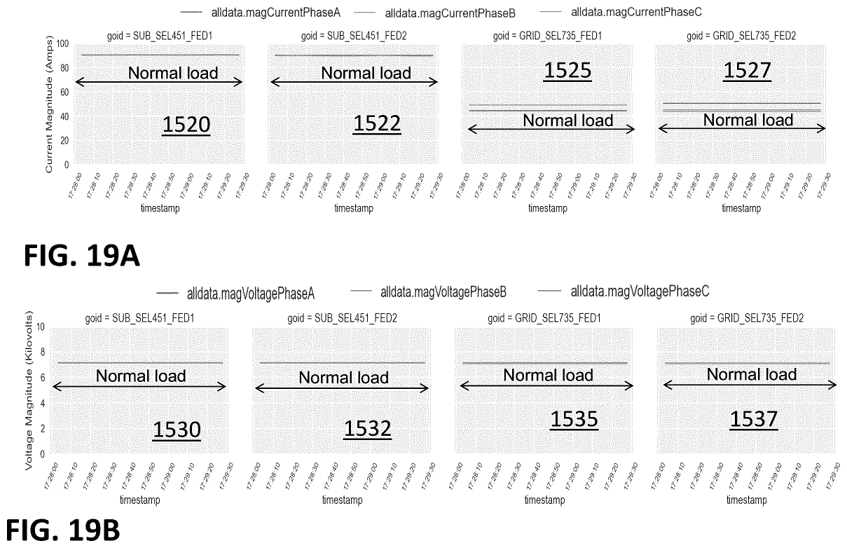

Experiment 1.a represents a normal load case based on the grid circuit associated with testbed diagram of FIG. 18A. FIG. 19A shows a plot of the data captured versus time during experiment 1.a including DLT current data 1520, 1522 from the protective relays 1502, 1505 (FIG. 18A) and plots of the current data 1525, 1527 from the power meters 1507, 1510 for experiment 1.a, and FIG. 19B shows plots of the data captured versus time during experiment 1.a including DLT voltage data 1530, 1532 from the protective relays 1502, 1505 (FIG. 18A) and plots of the voltages data 1535, 1537 from the power meters 1507, 1510 for experiment 1.a. The measured currents and voltages were constant for the duration of the experiment as expected since there were no electrical faults or cyber events. The Cyber Grid Guard system observed this behavior based on the packets that it received. In FIG. 19A, the currents didn't show the same magnitudes for the balanced loads, because of using amplifiers instead of the low-voltage level for the interface of power meters.

Experiment 1.b represents a normal load case with the EmSense device based on the grid circuit associated with testbed diagram of FIG. 18A. For the normal case, in which the EmSense device broadcast SV packets over the network, the Cyber Grid Guard system was still able to receive the broadcasted GOOSE packets from the four relevant devices without interference. The packets indicated the normal behavior for the relays and meters, meaning that EmSense did not impact the packets coming from the other devices.

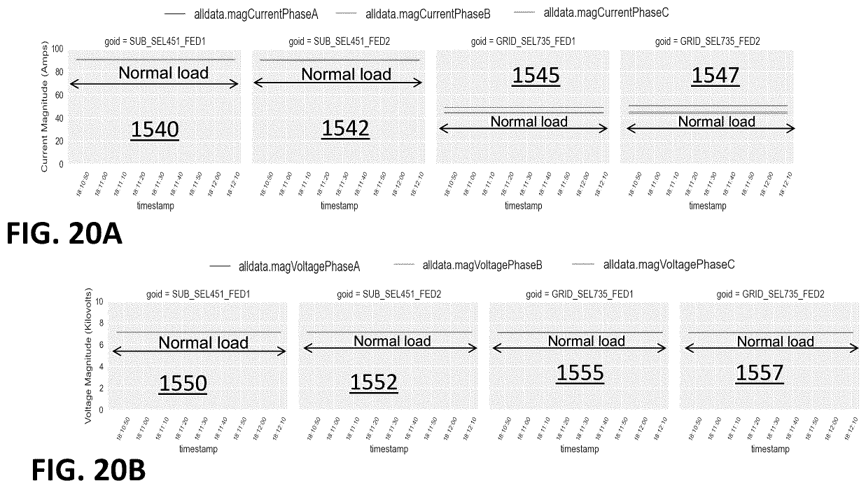

For Experiment 1.b, FIG. 20A shows plots of the phase currents 1540, 1542 for the relays 1502, 1505 (FIG. 18A) and current data plots 1545, 1547 from the power meters 1507, 1510. FIG. 20B shows plots of the phase voltages 1550, 1552 for the relays and voltages data 1555, 1557 from the power meters. The phase currents and voltages were constant for the duration of the experiment as expected since there were no electrical faults or cyber events. In FIG. 20A, the phase currents 1545, 1547 didn't show the same magnitudes for the balanced loads, because of using amplifiers instead of the low-voltage level interface for the power meters.

Experiment 2.a represents a normal load with a cyber event (change of current transformer ratio setting of feeder relay) based on the testbed diagram of FIG. 18A. FIGS. 21A, 21B show the data captured versus time during the experiment.

For Experiment 2.a, FIG. 21A shows plots of the phase currents 1560, 1562 for relays 1502, 1505 (FIG. 18A) and plots 1565, 1567 of the phase currents for meters 1507, 1510. FIG. 21B shows plots of the phase voltages 1570, 1572 for the relays and plots of the data 1575, 1577 from the power meters. For the command injection of a cyber event 1562, the overall behavior was not affected from the DLT master's perspective except for the phase currents measured by the “SUB_SEL451_FED2” relay that dropped drastically when the current transformer ratio setting was changed from 80 to 1. In FIG. 21A at 1565, 1567, the phase currents did not show the same magnitudes for the balanced loads, because of using amplifiers instead of the low-voltage interface level for the power meters.

Experiment 2.b represents a normal load with cyber event (open breaker from feeder relay) based on the grid-testbed diagram of FIG. 18A. FIGS. 22A, 22B shows the data captured versus time during the experiment.

For Experiment 2.b, FIG. 22A shows plots of the phase currents 1580, 1582 for the relays 1502, 1505 (FIG. 18A) and plots 1585, 1587 of the phase currents for the power meters 1507, 1510. FIG. 22B shows plots of the phase voltages 1590, 1592 for the relays and plots of the voltages data 1595, 1597 for the meters. For the cyber event case when the breaker was opened, the phase currents dropped to zero as shown at 1582 in FIG. 22A and the nominal voltages 1592 were measured for the “SUB_SEL451_FED2” relay, which was approximately at 50 s from starting the simulation. The Cyber Grid Guard system observed the behavior for the measured phase currents and voltages of the “SUB_SEL451_FED2” relay. In addition, when the breaker was opened for the “SUB_SEL451_FED2” relay, the phase currents 1585, 1587 of FIG. 22A and voltages 1595, 1597 of FIG. 22B of the power 735 meters decreased up to zero. It was because the power meters were in the same circuit path of the “SUB_SEL451_FED2” relay. In FIG. 22A at 1585, 1587, the phase currents did not show the same magnitudes for the balanced loads, because of using amplifiers instead of the low-voltage level interface for the power meters.

Experiments with Electrical Fault Events

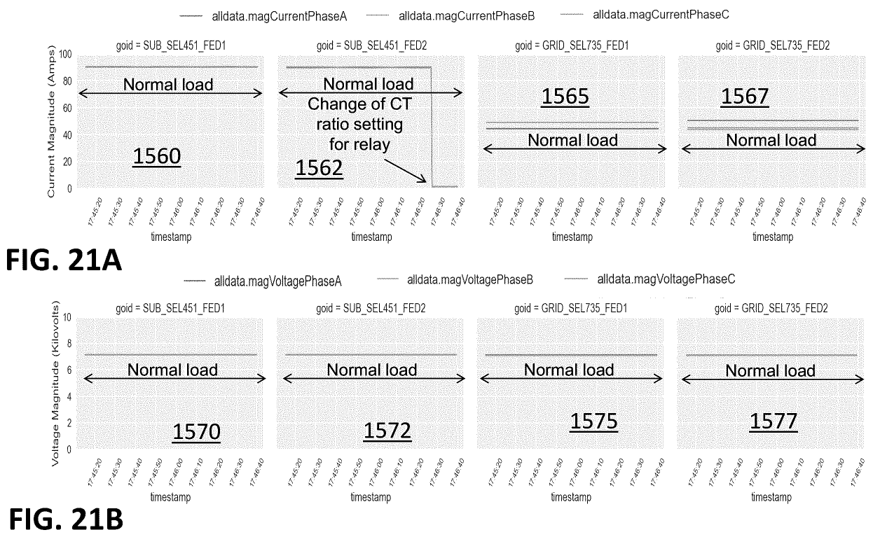

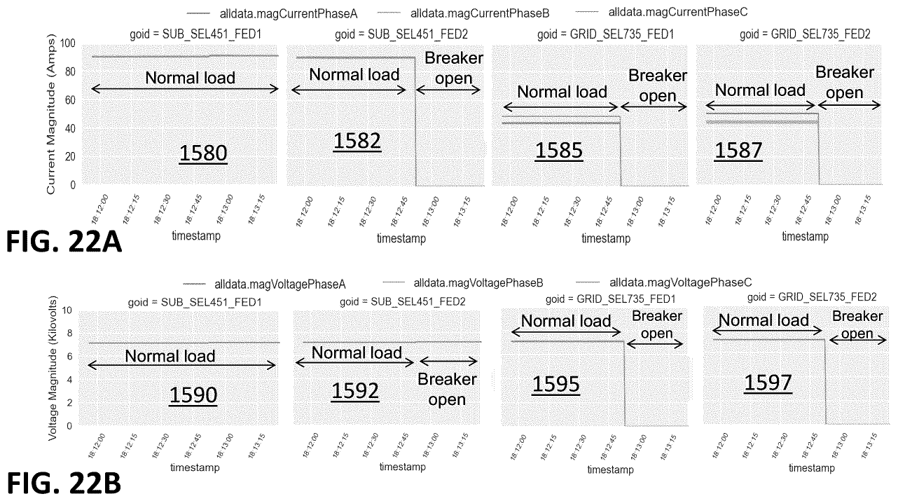

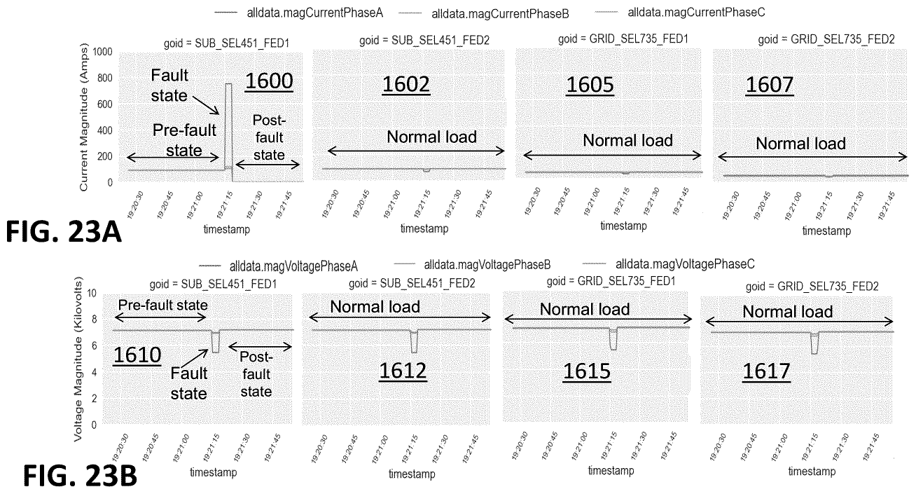

Experiment 3.a represents a SLG electrical fault at the 50 T fuse feeder based on the grid-testbed diagram of FIG. 18A. During this SLG electrical fault affecting phase A, the Cyber Grid Guard system observed a significant increase in the current of phase A for the “SUB_SEL451_FED1” relay, as shown in FIG. 23A which shows plots 1600, 1602 of the DLT current data from the protective relays 1502, 1505 (FIG. 18A) and plots 1605, 1607 of the DLT current data from the power meters 1507, 1510 for Experiment 3.a. FIG. 23B shows plots of the phase voltages 1610, 1612 for the relays and plots of the voltages data 1615, 1617 for the power meters.

In the Experiment 3.a, the phase A was grounded at 50 T fuse feeder bus. Once the phase A current increased at the fault state at 1600, FIG. 23A, the “SUB_SEL451_FED1” relay detected it, and the relay opened the breaker. Then, after the SLG electrical fault was cleared at the post-fault state, the phase currents dropped to zero at 1600, FIG. 23A, and the nominal phase voltages were measured shown at 1610 in FIG. 23B. The electrical circuit path that was not affected directly by the SLG electrical measured a short-time disturbance for the phase currents 1602, 1605, 1607 of FIG. 23A and voltages 1612, 1615, 1617 of FIG. 23B.

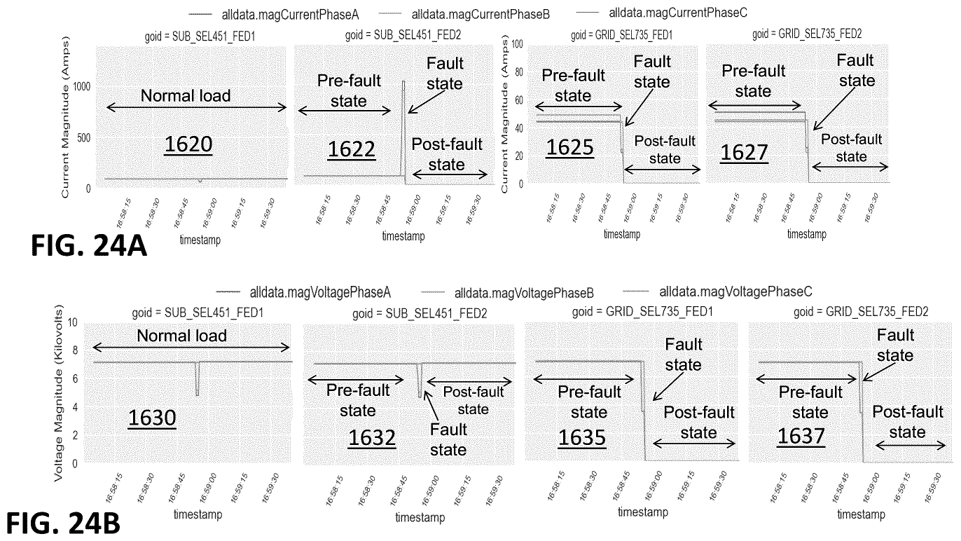

Experiment 3.b represents a LL electrical fault at the 100 T fuse feeder based on the grid-testbed diagram of FIG. 18A. During this LL electrical fault affecting phase A and B, the Cyber Grid Guard system observed a significant increase in the current of phase A and B for the “SUB_SEL451_FED2” relay, as shown in the plot 1622 in FIG. 24A. FIG. 24A shows plots of DLT current data 1620, 1622 from the protective relays 1502, 1505 (FIG. 18A) and plots 1625, 1627 of the DLT current data from the power meters 1507, 1510 for Experiment 3.b. FIG. 24B shows plots of the phase voltages 1630, 1632 for the relays and plots of the voltages data 1635, 1637 for the power meters.

In the Experiment 3.b, the phase A and B were faulted (without grounding) at the 100 T fuse feeder bus. Once the phase A and B current increased at the fault state 1622, FIG. 24A, the “SUB_SEL451_FED2” relay detected it, and the relay opened the breaker. Then, after the LL electrical fault was cleared by the breaker at the post-fault state, the measured phase currents from the “SUB_SEL451_FED2” relay dropped to zero as shown in 1622, FIG. 24A. However, the nominal phase voltages were measured at the post-fault state as shown at 1632, FIG. 24B. When the breaker was tripped by the “SUB_SEL451_FED2” relay, the power meters showed how the phase currents 1625, 1627 and voltages 1635, 1637 dropped to zero. The electrical circuit path that was not affected directly by the LL electrical fault measured a short-time disturbance for the phase currents shown at 1620, FIG. 24A and voltages shown at 1630, FIG. 24B.

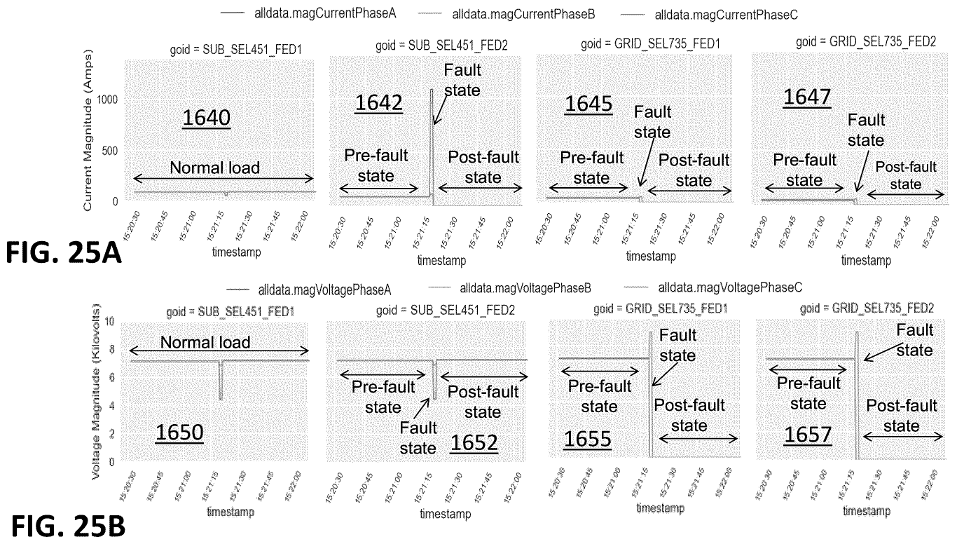

Experiment 3.c represents a LLG electrical fault at the 100T fuse feeder based on the grid-testbed diagram of FIG. 18A. During this LLG electrical fault affecting phase A and B, the Cyber Grid Guard system observed a significant increase in the current of phase A and B for the “SUB_SEL451_FED2” relay, as shown at 1642, FIG. 25A. FIG. 25A shows plots of DLT current data 1640, 1642 from the protective relays 1502, 1505 (FIG. 18A) and plots 1645, 1647 of the DLT current data from the power meters 1507, 1510 for Experiment 3.c. FIG. 25B shows plots of the phase voltages 1650, 1652 for the relays and plots of the voltages data 1655, 1657 for the power meters.

In the Experiment 3.c, the phase A and B were grounded at the 100T fuse feeder bus. Once the phase A and B current increased at the fault state as shown in 1642, FIG. 25A, the “SUB_SEL451_FED2” relay detected it, and the relay opened the breaker. When the breaker was tripped at the post-fault state, the phase currents from the “SUB_SEL451_FED2” relay dropped to zero as shown at 1642, FIG. 25A. However, the nominal phase voltages from the “SUB_SEL451_FED2” relay were measured at 1652, FIG. 25B. The LLG electrical faults produced an overvoltage in the non-faulted power line (phase C) at the fault location, and it was measured by the power meters as shown in plots 1655, 1657, FIG. 25B. The electrical circuit path that was not affected directly by the LLG electrical fault measured a short-time disturbance for the phase currents as shown at 1640, FIG. 25A and voltages 1650, FIG. 25B.

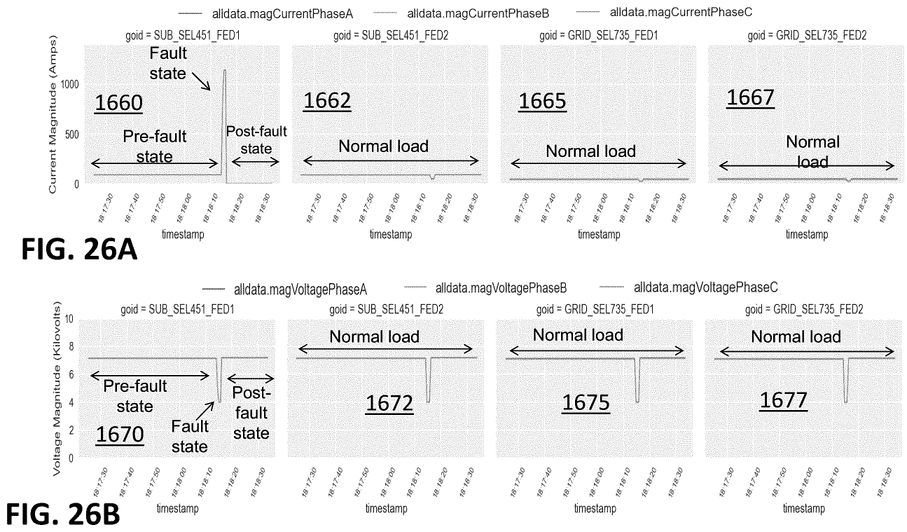

Experiment 3.d represents a 3LG electrical fault at the 50T fuse feeder based on the grid-testbed diagram of FIG. 18A. During this 3LG electrical fault affecting the phase A, B and C, the Cyber Grid Guard system observed a significant increase in all phase currents for the “SUB_SEL451_FED1” relay, as shown at 1662, FIG. 26A. FIG. 26A shows plots of DLT current data 1660, 1662 from the protective relays 1502, 1505 (FIG. 18A) and plots 1665, 1667 of the DLT current data from the power meters 1507, 1510 for Experiment 3.d. FIG. 26B shows plots of the phase voltages 1670, 1672 for the relays and plots of the voltages data 1675, 1677 for the power meters.

In the Experiment 3.d, the phase A, B and C were grounded at the 50T fuse feeder bus. Once all phase currents increased at the fault state as shown in 1660, FIG. 26A, the “SUB_SEL451_FED1” relay detected it, and the relay opened the breaker. Then, the measured phase currents from the “SUB_SEL451_FED1” relay dropped to zero at the post-fault state at 1660, FIG. 26A. However, the nominal phase voltages were measured from the “SUB_SEL451_FED1” relay at the post-fault state as shown at 1670, FIG. 26B. The electrical circuit path that was not affected directly by the 3LG electrical fault measured a short-time disturbance for the phase currents as shown in 1662, 1665, 1667, FIG. 26A and for voltages 1672, 1675, 1677, FIG. 26B.

Experiment with Combined Cyber and Electrical Fault Events

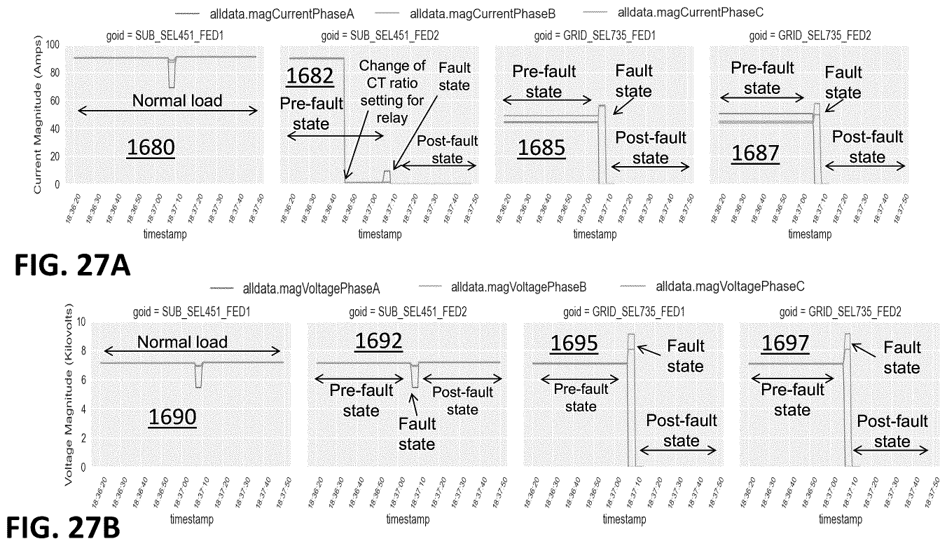

Experiment 4.a represents a SLG electrical fault at the 100T fuse feeder and cyber event (change the current transformer ratio setting of the feeder relay), based on the grid-testbed diagram of FIG. 18A. Before the application of the SLG electrical fault, the current transformer ratio of the “SUB_SEL451_FED2” relay was changed from 80 to 1, and the measured phase currents decreased drastically, as shown in plot 1682, FIG. 27A. FIG. 27A shows plots of DLT current data 1680, 1682 from the protective relays 1502, 1505 (FIG. 18A) and plots 1685, 1687 of the DLT current data from the power meters 1507, 1510 for Experiment 4.a. FIG. 27B shows plots of the phase voltages 1690, 1692 for the relays and plots of the voltages data 1695, 1697 for the power meters.

Then, the SLG electrical fault affecting phase A was performed at roughly 50 s. into the simulation. During this experiment, the Cyber Grid Guard system observed a non-significant increase in the current of phase A for the “SUB_SEL451_FED2” relay as shown at 1682, FIG. 27A. This situation is because the current transformer ratio of the “SUB_SEL451_FED2” relay was modified. However, the relay tripped because the inverse time overcurrent setting did not depend on the current transformer ratio setting. Once the phase A current increased at the fault state, the “SUB_SEL451_FED2” relay detected it, and the relay opened the breaker. Then, the measured phase currents from the “SUB_SEL451_FED2” dropped to zero at the post-fault state 1682, FIG. 27A. In addition, the nominal phase voltages from the “SUB_SEL451_FED2” relay were measured at the post-fault state as shown at 1692, FIG. 27B. The electrical circuit path that was not affected directly by the SLG electrical fault measured a short-time disturbance for the phase currents at 1680, FIG. 27A and for the voltages at 1690, FIG. 27B.

The attestation framework of FIG. 1 can handle stress and high data bandwidth, such as multiple high-fidelity sensors in the 10 kHz and above range.

### Example Scenario

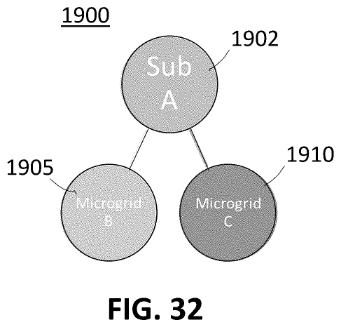

FIG. 32 depicts an example use case scenario 1900 depicting a substation A 1902 that provides the framework to support attestation and anomaly detection in an electric grid that can be implemented to provide attestation services for independently owned microgrid B 1905 and microgrid C 1910. Substation A 1902 can operate attestation services described herein for substation B 1905 and/or operate attestation services for substation C 1910. In an embodiment, substation A 1902 can be an electrical substation and microgrids B 1905 and C 1910 can include a DER such as wind turbine farms and/or inverter-based photovoltaic array farms.

In a detailed scenario, a utility A 1902 may want to determine that a given utility B's substation or microgrid system 1905 is “uncompromised,” e.g., free of malware, viruses, worms, and so on, before accepting energy data, e.g., related to protection such as power quality, fault data etc., from them. From Utility A's point of view this is a reasonable idea, as they have a business incentive to keep their network/systems free from being abused.

However, from the point of view of Utility B 1905 some other concerns are just as important. Utility B wants to access the electric energy, and potentially protection data, from Utility A, but also does not want to share all the details of their systems, e.g., IEDs, contents, e.g., configuration details/firmware version, etc., with Utility A. Utility B might, however, trust the Cyber Grid Guard framework with the information necessary to determine if they are “uncompromised”

Additionally, Utility A might also trust the DLT framework's assertions about whether a given Utility's system is “uncompromised” enough to be connected to their network. This delegation of appraisal to Cyber Grid Guard could suit the needs of all in this simple situation.

An attestation framework implements systems and methods that can ingest data from a network and secure the data with the blockchain. The Cyber Grid Guard system can process large quantities of data quickly and the framework can handle high-velocity, high-volume packet traffic. The framework can manage very high-speed data, e.g., when processing this data from high-fidelity sensors, such as EmSense.

The attestation framework is effective to attest to system changes and anomaly detection in helping to flag specific events based on statistical threshold values. The attestation framework can support the detection of system changes by itself, but when combined with an anomaly detection framework, it has a lower system resource requirement and may be more likely to catch system changes with minimal impact on CPU usage.

The framework can handle stress and high data bandwidth, such as multiple high-fidelity sensors, e.g., in the 10 kHz and above range. The data can be captured correctly and attested to by the Cyber Grid Guard framework 10 using the blockchain DLT and may be also used for additional post-mortem analysis in addition to or alongside historical data for a confidence analysis with more than historical data alone given the data tampering resistance of the DLT.

The system and method can be deployed at substations or other environments, such as DERs or a microgrid. In so doing, the technology is agnostic to the environment where it is deployed and can enable handling multiple SCADA protocols and types of edge devices that include relays of various brands. The system and methods can be used to create a better set of potential cyber event scenarios in which cryptographic keys are compromised and can improve the understanding of how the DLTs are able to respond to compromised nodes and such scenarios.

Various aspects of the present disclosure may be embodied as a program, software, or computer instruction embodied or stored in a computer or machine usable or readable medium, or a group of media that causes the computer or machine to perform the steps of the method when executed on the computer, processor, and/or machine. A program storage device readable by a machine, e.g., a computer-readable medium, tangibly embodying a program of instructions executable by the machine to perform various functionalities and methods described in the present disclosure is also provided, e.g., a computer program product.

The computer-readable medium could be a computer-readable storage device or a computer-readable signal medium. A computer-readable storage device may be, for example, a magnetic, optical, electronic, electromagnetic, infrared, or semiconductor system, apparatus, or device, or any suitable combination of the foregoing; however, the computer-readable storage device is not limited to these examples except a computer-readable storage device excludes computer-readable signal medium. Additional examples of computer-readable storage device can include: a portable computer diskette, a hard disk, a magnetic storage device, a portable compact disc read-only memory (CD-ROM), random access memory (RAM), read-only memory (ROM), an erasable programmable read-only memory (EPROM or Flash memory), an optical storage device, or any appropriate combination of the foregoing; however, the computer-readable storage device is also not limited to these examples. Any tangible medium that can contain, or store, a program for use by or in connection with an instruction execution system, apparatus, or device could be a computer-readable storage device.

A computer-readable signal medium may include a propagated data signal with computer-readable program code embodied therein, such as, but not limited to, in baseband or as part of a carrier wave. A propagated signal may take any of a plurality of forms, including, but not limited to, electromagnetic, optical, or any suitable combination thereof. A computer-readable signal medium may be any computer-readable medium (exclusive of computer-readable storage device) that can communicate, propagate, or transport a program for use by or in connection with a system, apparatus, or device. Program code embodied on a computer-readable signal medium may be transmitted using any appropriate medium, including but not limited to wireless, wired, optical fiber cable, RF, etc., or any suitable combination of the foregoing.

The processor(s) described herein, e.g., a hardware processor, may be a central processing unit (CPU), a graphics processing unit (GPU), a field programmable gate array (FPGA), an application specific integrated circuit (ASIC), another suitable processing component or device, or one or more combinations thereof. The storage(s) may include random access memory (RAM), read-only memory (ROM) or another memory device, and may store data and/or processor instructions for implementing various functionalities associated with the methods and/or systems described herein.

The terminology used herein is for the purpose of describing aspects only and is not intended to be limiting the scope of the disclosure and is not intended to be exhaustive. Many modifications and variations will be apparent to those of ordinary skill in the art without departing from the scope and spirit of the disclosure.

What is claimed is:

1. A system for electrical-energy delivery, the system comprising:
multiple electrical grid devices each configured to transmit associated electrical grid data signal values and associated device-configuration data over a communications network;
one or more hardware processor devices communicatively coupled with the electrical grid devices through the communications network, the one or more hardware processor devices configured to receive electrical grid data signal values from an electrical grid device and the associated device-configuration data from the electrical grid device and apply a hash function to the associated device-configuration data received from the electrical grid device to obtain an associated hashed baseline configuration artifact data value;
at least one Distributed Ledger Technology (DLT) data storage device communicatively coupled with one or more hardware processor devices through the communications network, the at least one DLT data storage device storing an instance of a ledger, the DLT data storage device configured to store in the ledger the associated hashed baseline configuration artifact data value;
the one or more hardware processor devices further configured to extract features of the electrical grid data signal values received from the electrical grid device during real-time operation;
the one or more hardware processor devices further configured to detect an anomalous event based on the extracted features; and responsive to detection of an anomalous event, the one or more hardware processors verifying an integrity of the corresponding electrical grid device using said associated hashed baseline configuration artifact data value for that corresponding electrical grid device stored in the at least one DLT data storage device.

2. The system of claim 1, further comprising:
an off-chain data storage device communicatively coupled with the one or more hardware processors through the communications network, wherein the one or more hardware processors are further configured to create baseline threshold values of the extracted features and store said created baseline threshold values in said off-chain data storage device.

3. The system of claim 2, wherein the one or more hardware processors are configured to create baseline threshold values of the extracted features at predetermined times or at random times.

4. The system of claim 2, wherein said created baseline threshold values of the extracted features comprise a statistical baseline threshold value comprising one or more of: a standard deviation and a statistical mean calculated for network traffic parameters associated with data packets of associated electrical grid data signal values transmitted over the network, said network traffic parameters comprising one or more of: interarrival packet time, packet loss rate, throughput, jitter, packet sizes, timing information, source/destination addresses, and protocol types.

5. The system of claim 2, wherein to detect an anomalous event based on the extracted features, said one or more hardware processor devices are configured to:
receive real-time or near real-time electrical grid data signal values from the electrical grid device;
create a corresponding baseline value of said real-time or near real-time electrical grid data signal values;
compare the corresponding baseline value of said received real-time or near real-time electrical grid data signal values against the created baseline threshold values stored in the off-chain data storage device for that corresponding electrical grid device; and
determine an anomalous event when a corresponding baseline value of said received real-time or near real-time electrical grid data signals is different from the created baseline threshold value stored in the off-chain data storage device.

6. The system of claim 5, wherein responsive to detecting an anomalous event, said one or more hardware processors are further configured to:
trigger an integrity verification of one or more electrical grid devices.

7. The system of claim 2, wherein the one or more hardware processor devices are further configured to: monitor power system parameter values of said electrical grid devices generating electric power, the created baseline threshold values stored in said off-chain data storage device comprising historical baseline data values obtained using statistical moving averages or statistical standard deviation value relating to monitored power system parameters, said monitored power system parameters comprising one or more of: voltage and current levels, a breaker status, a pattern in power factor or frequency.

8. The system of claim 7, wherein to detect an anomalous event based on the extracted features, said one or more hardware processor devices are configured to:
compare the monitored power system parameter values of said electrical grid devices against said historical baseline data values stored in the off-chain data storage device; and
determine an anomalous event when a monitored power system parameter value is different from the historical baseline data value.

9. The system of claim 8, wherein responsive to detecting an anomalous event, said one or more hardware processors are further configured to:
store detailed information about the detected anomaly in the off-chain database for subsequent analysis; and
alert an entity to perform a manual integrity verification of the one or more electrical grid devices.

10. The system of claim 6, wherein an anomalous event comprises: an electrical fault event, a cyber event, a change in a network device setting, a network traffic fault based on a network traffic parameter statistic associated with data packets transmitted over said communications network, and a deviation from a normal operational parameter, said deviation from a normal operational parameter comprising one or more of: abnormal voltage and current levels, unexpected changes in breaker status, unusual patterns in power factor or frequency.

11. The system of claim 6, wherein to verify an integrity of one or more electrical grid devices, said one or more hardware processor devices are configured to:
obtain from a corresponding electrical grid device, a current instance of its device-configuration data;
apply a cryptographic hash function to a current instance of the corresponding electrical grid device's configuration data to obtain a current configuration artifacts hash value;
compare the current configuration artifacts hash value with the associated hashed baseline configuration artifact data value for that corresponding electrical grid device stored in the at least one DLT data storage device; and
determine a compromised electrical grid-device or anomalous event based on a result of the comparison.

12. The system of claim 11, wherein said one or more hardware processor devices are further configured to:
update the associated hashed baseline configuration artifact data value stored for that corresponding electrical grid device in the at least one DLT data storage device using a time-based or event-driven approach.

13. The system of claim 12, wherein to update said associated hashed baseline configuration artifact data value for that corresponding electrical grid device, said one or more hardware processor devices are further configured to:
invoke an application programming interface (API) to retrieve configuration artifacts in real-time to minimize latency when integrity verifying.

14. The system of claim 11, wherein said configuration artifact data value comprises one or more of: a protection relay setting, an overcurrent protection parameter value, a network switch configuration, a virtual local area network setting, and control logic of a remote terminal unit.

15. The system of claim 6, wherein said electrical grid device comprises a sensor providing sensor measurements data, said one or more hardware processors further configured to one or more of:
aggregate packets having said sensor measurements data over a pre-determined time window, said baseline value of said real-time electrical grid data signal values corresponding to said aggregated packets within said pre-determined time window; and
apply Fast Fourier Transform (FFT) function to sensor measurements data for a frequency analysis, wherein the pre-determined time window for aggregating electrical grid data signals is configurable.

16. A method for managing information associated with an electrical utility grid comprising:
receiving, at one or more hardware processors of a computing node, electrical grid data signal values and associated device-configuration data transmitted from multiple electrical grid devices over a communication network;
storing, by the one or more hardware processors of a computing node, electrical grid data signal values and associated device-configuration data at an off-chain data storage device communicatively coupled with the one or more hardware processors through the communications network;
applying a hash function to the associated device-configuration data received from the electrical grid device to obtain an associated hashed baseline configuration artifact data value;
storing the associated hashed baseline configuration artifact data value at a ledger instance associated with at least one Distributed Ledger Technology (DLT) data storage device communicatively coupled with the one or more hardware processor devices through the communications network;
extracting, by the one or more hardware processors, features of the electrical grid data signal values received during real-time operation from the corresponding electrical grid device and storing extracted features in said off-chain database;
detecting, by the one or more hardware processors, an anomalous event based on the extracted features of the electrical grid data signal values; and
verifying, by the one or more hardware processors, responsive to detection of an anomalous event, an integrity of the corresponding electrical grid device using said associated hashed baseline configuration artifact data value for that corresponding electrical grid device stored in the at least one DLT data storage device.

17. The method of claim 16, further comprising:
creating, by the one or more processor devices, baseline threshold values of the extracted features and storing said created baseline threshold values in said off-chain data storage device.

18. The method of claim 17, further comprising:
creating, using the one or more hardware processors, the baseline threshold values of the extracted features at predetermined times or at random times.

19. The method of claim 17, wherein said created baseline threshold values of the extracted features comprise a statistical baseline threshold value comprising one or more of: a standard deviation and a statistical mean calculated for network traffic parameters associated with data packets of associated electrical grid data signal values transmitted over the network, said network traffic parameters comprising one or more of: interarrival packet time, packet loss rate, throughput, jitter, packet sizes, timing information, source/destination addresses, and protocol types.

20. The method of claim 17, wherein to detect an anomalous event based on the extracted features, said method further comprises:
receiving, by said one or more hardware processor devices, real-time or near real-time electrical grid data signal values from the electrical grid device;
creating, by said one or more hardware processor devices, a corresponding baseline value of said real-time or near real-time electrical grid data signal values;
comparing, by said one or more hardware processor devices, the corresponding baseline value of said received real-time or near real-time electrical grid data signal values against the created baseline threshold values stored in the off-chain data storage device for that corresponding electrical grid device; and
determining an anomalous event when a corresponding baseline value of said real-time or near received real-time electrical grid data signals is different from the created baseline threshold value stored in the off-chain data storage device.

21. The method of claim 20, further comprising:
triggering, by said one or more hardware processor devices, an integrity verification of one or more electrical grid devices responsive to determining said anomalous event.

22. The method of claim 17, further comprising:
monitoring, by said wherein the one or more hardware processor devices, power system parameter values of said electrical grid devices generating electric power, the created baseline threshold values stored in said off-chain data storage device comprising historical baseline data values obtained using statistical moving averages or statistical standard deviation value relating to monitored power system parameters, said monitored power system parameters comprising one or more of: voltage and current levels, a breaker status, a pattern in power factor or frequency.

23. The method of claim 22, wherein the detection of an anomalous event based on the extracted features further comprises:
comparing, by said one or more hardware processor devices, the monitored power system parameter values of said electrical grid devices against said historical baseline data values stored in the off-chain data storage device; and
determining an anomalous event when a monitored power system parameter value is different from the stored historical baseline data value.

24. The method of claim 23, wherein responsive to detecting an anomalous event, said method further comprising:
storing, by said one or more hardware processors, detailed information about the detected anomaly in the off-chain database for subsequent analysis; and
alerting an entity to perform a manual integrity verification of the one or more electrical grid devices.

25. The method of claim 21, wherein an anomalous event comprises: an electrical fault event, a cyber event, a change in a network device setting, a network traffic fault based on a network traffic parameter statistic associated with data packets transmitted over said communications network, and a deviation from a normal operational parameter, said deviation from a normal operational parameter comprising one or more of: abnormal voltage and current levels, an unexpected changes in breaker status, an unusual pattern in power factor or frequency.

26. The method of claim 21, wherein the verifying integrity of one or more electrical grid devices comprises:
obtaining from a corresponding electrical grid device, a current instance of its device-configuration data;
applying, by said one or more hardware processor devices, a cryptographic hash function to a current instance of the corresponding electrical grid device's configuration data to obtain a current configuration artifacts hash value;
comparing, by said one or more hardware processor devices, the current configuration artifacts hash value with the associated hashed baseline configuration artifact data value for that corresponding electrical grid device stored in the at least one DLT data storage device; and
determining a compromised electrical grid device or anomalous event based on a result of the comparison.

27. The method of claim 26, further comprising:
updating, by the one or more hardware processor devices, the associated hashed baseline configuration artifact data value stored for that corresponding electrical grid device in at least one DLT data storage device using a time-based or event-driven approach.

28. The method of claim 27, wherein the updating said associated hashed baseline configuration artifact data value comprises:
invoking, by the one or more hardware processor devices, an application programming interface (API) to retrieve configuration artifacts in real-time to minimize latency when integrity verifying.

29. The method of claim 27, wherein said configuration artifact data value comprises one or more of: a protection relay setting, an overcurrent protection parameter value, a network switch configuration, a virtual local area network setting, and control logic of a remote terminal unit.

30. The method of claim 21, wherein said electrical-grid device comprises a sensor providing sensor measurements data, said method further comprises one or more of:
aggregating packets having said sensor measurements data over a pre-determined time window said baseline value of said real-time electrical-grid data signal values corresponding to said aggregated packets within said pre-determined time window; and
applying, by said one or more hardware processor devices, a Fast Fourier Transform (FFT) function to said sensor measurement data for frequency analysis, wherein the pre-determined time window for aggregating electrical grid data signals is configurable.
